(19) United States
(12) Patent Application Publication
(10) Pub. No.: US 2015/0212724 A1
(43) Pub. Date: Jul. 30, 2015

(54) MANIPULATION INPUT DEVICE, MANIPULATION INPUT METHOD, MANIPULATION INPUT PROGRAM, AND ELECTRONIC APPARATUS

(71) Applicant: Sharp Kabushiki Kaisha, Osaka-shi, Osaka (JP)

(72) Inventor: Osamu Manba, Osaka-shi (JP)

(21) Appl. No.: 14/419,732

(22) PCT Filed: Aug. 1, 2013
(86) PCT No.: PCT/JP2013/070872

§ 371 Date: Feb. 5, 2015

(30) Foreign Application Priority Data
Aug. 8, 2012 (JP) 2012-175958

(51) Int. Cl. G06F 3/0488; G06F 3/041; G06F 3/0484; G06F 3/0482; G06F 3/0481

(52) U.S. Cl. CPC G06F 3/04883; G06F 3/0482; G06F 3/0481; G06F 3/04845; G06F 3/0412; G06F 3/0416

(57) ABSTRACT

A contact area detection unit configured to detect a contact area in which a manipulation object comes in contact with a manipulation input unit that receives a manipulation input. A proximity area detection unit configured to detect a proximity area in which the manipulation object is close to the manipulation input unit without coming in contact with the manipulation input unit. A screen component adjustment unit configured to determine a screen component area in which a screen component constituting a screen display is displayed, the determination being performed based on an overlap area, the overlap area being an area in which the screen component area and an area including the contact area detected by the contact area detection unit and the proximity area detected by the proximity area detection unit overlap.

### TECHNICAL FIELD

The present invention relates to a manipulation input device, a manipulation input method, a manipulation input program, and an electronic apparatus.

Priority is claimed on Japanese Patent Application No. 2012-175958, filed Aug. 8, 2012, the content of which is incorporated herein by reference.

### BACKGROUND ART

In recent years, a touch panel has become widespread as a manipulation input device in a portable terminal device, including a multifunctional portable phone (so-called smartphone). The touch panel is a pointing device capable of pointing to a coordinate on a screen of a display device when a user performs a manipulation while coming in contact with the touch panel with his or her finger as a manipulation object.

Meanwhile, the portable terminal device may include a display unit that displays a screen component for each realizable function. The user points to one of the displayed screen components using the touch panel to realize a desired function.

For example, an input device described in Patent Document 1 includes a display pattern storage unit that stores, as a display position of a screen component, a position in which a display of the screen component is not covered with a manipulation object, such as a hand of a manipulator, in association with a direction from which the manipulation object touches a touch surface. The display position in which the display is not covered with the manipulation object is determined from the display pattern storage unit based on the direction of the manipulation object, to thereby display the screen component on the screen of the display device in response to the touch of the touch surface.

### PRIOR ART DOCUMENT

### Patent Document

[Patent Document 1] Japanese Unexamined Patent Application, First Publication No. 2010-287032

### SUMMARY OF INVENTION

### Problem to be Solved by the Invention

However, the portable terminal device is used in various arrangements due to a variety of use forms. For example, the portable terminal device is often gripped so that one end in a longitudinal direction is directed upward at the time of a call, whereas the portable terminal device is placed so that a surface in a thickness direction is directed upward or so that the surface in the thickness direction is directed obliquely upward toward a user when text information is input. Therefore, when the screen component is displayed in a position stored as the position in which the display is not covered, the screen component is covered with the manipulation object, thereby degrading operability.

The present invention has been made in view of the aforementioned circumstances and provides a manipulation input device, a manipulation input method, a manipulation input program, and an electronic apparatus in which operability is not degraded.

### Means to Solve the Problem

(1) The present invention is made to solve the above-described problem, one aspect of the present invention is a manipulation input device including: a contact area detection unit configured to detect a contact area in which a manipulation object comes in contact with a manipulation input unit that receives a manipulation input; a proximity area detection unit configured to detect a proximity area in which the manipulation object is close to the manipulation input unit without coming in contact with the manipulation input unit; and a screen component adjustment unit configured to determine a screen component area in which a screen component constituting a screen display is displayed, the determination being performed based on an overlap area, the overlap area being an area in which the screen component area and an area including the contact area detected by the contact area detection unit and the proximity area detected by the proximity area detection unit overlap.

(2) Another aspect of the present invention is, in the above-described manipulation input device, the screen component adjustment unit is configured to adjust the screen component area so that the overlap area based on the screen component area becomes smaller.

(3) Another aspect of the present invention is, in the above-described manipulation input device, in case that a plurality of adjustment aspects for adjusting an arrangement of the screen component are determined, the screen component adjustment unit is configured to sequentially adjust the arrangement of the screen component in each of the plurality of adjustment aspects according to a priority that differs according to a type of screen component.

(4) Another aspect of the present invention is, in the above-described manipulation input device, in case that a plurality of adjustment aspects for adjusting an arrangement of the screen component are determined, the screen component adjustment unit is configured to determine the adjustment aspect in which the overlap area is minimized among the plurality of adjustment aspects.

(5) Another aspect of the present invention is, in the above-described manipulation input device, the adjustment aspect is any one or a combination of movement and deformation.

(6) Another aspect of the present invention is, in the above-described manipulation input device, the screen component adjustment unit is configured to detect a direction in which a finger of a user is placed as the manipulation object based on the contact area and the proximity area, and determine the screen component area to be away from the detected direction.

(7) Another aspect of the present invention is, in the above-described manipulation input device, the screen component adjustment unit is configured to determine a size of the screen component area based on pressing force in case that the manipulation object comes in contact with the manipulation input unit.

(8) Another aspect of the present invention is, in the above-described manipulation input device, the manipulation input device includes: a direction detection unit configured to detect a direction in which the manipulation input device is directed, wherein the screen component adjustment unit is configured to determine the screen component area based on the direction detected by the direction detection unit.

(9) Another aspect of the present invention is, in the above-described manipulation input device, the screen component adjustment unit is configured to replicate the screen component area in a position that does not overlap the area including the contact area and the proximity area in case that the overlap area is greater than a predetermined index value.

(10) Another aspect of the present invention is a manipulation input method used by a manipulation input device, the manipulation input method including: a first process of detecting, by the manipulation input device, a contact area in which a manipulation object comes in contact with a manipulation input unit that receives a manipulation input; a second process of detecting, by the manipulation input device, a proximity area in which the manipulation object is close to the manipulation input unit without coming in contact with the manipulation input unit; and a third process of determining, by the manipulation input device, a screen component area in which a screen component constituting a screen display is displayed, the determination being performed based on an overlap area, the overlap area being an area in which the screen component area and an area including the contact area detected in the first process and the proximity area detected in the second process overlap.

(11) Another aspect of the present invention is a manipulation input program used in a computer of a manipulation input device including a contact area detection unit that detects a contact area in which a manipulation object comes in contact with a manipulation input unit that receives a manipulation input, and a proximity area detection unit that detects a proximity area in which the manipulation object is close to the manipulation input unit without coming in contact with the manipulation input unit, the manipulation input program including: a process of determining a screen component area in which a screen component constituting a screen display is displayed, the determination being performed based on an overlap area, the overlap area being an area in which the screen component area and an area including the contact area detected by the contact area detection unit and the proximity area detected by the proximity area detection unit overlap.

(12) Another aspect of the present invention is an electronic apparatus including: a contact area detection unit configured to detect a contact area in which a manipulation object comes in contact with a manipulation input unit that receives a manipulation input; a proximity area detection unit configured to detect a proximity area in which the manipulation object is close to the manipulation input unit without coming in contact with the manipulation input unit; and a screen component adjustment unit configured to determine a screen component area in which a screen component constituting a screen display is displayed, the determination being performed based on an overlap area, the overlap area being an area in which the screen component area and an area including the contact area detected by the contact area detection unit and the proximity area detected by the proximity area detection unit overlap.

### Effect of the Invention

According to the present invention, it is possible to provide the manipulation input device, the manipulation input method, the manipulation input program, and the electronic apparatus in which good operability can be maintained.

### BRIEF DESCRIPTION OF DRAWINGS

FIG. 1 is a conceptual diagram illustrating an appearance configuration of an electronic apparatus 1 according to a first embodiment of the present invention.

FIG. 2 is a block diagram illustrating an internal configuration of a display device 1.

FIG. 3 is a block diagram illustrating a configuration of a control unit.

FIG. 4 is a flowchart illustrating a process in the control unit.

FIG. 5A is a first schematic diagram illustrating an example of screen display and a detection area.

FIG. 5B is a second schematic diagram illustrating an example of screen display and a detection area.

FIG. 6A is a first schematic diagram illustrating an example of detection of a contact area and a proximity area by a touch panel.

FIG. 6B is a second schematic diagram illustrating an example of detection of a contact area and a proximity area by a touch panel.

FIG. 6C is a third schematic diagram illustrating an example of detection of a contact area and a proximity area by a touch panel.

FIG. 6D is a fourth schematic diagram illustrating an example of detection of a contact area and a proximity area by a touch panel.

FIG. 7A is a first schematic diagram illustrating another example of detection of a contact area and a proximity area by a touch panel.

FIG. 7B is a second schematic diagram illustrating another example of detection of a contact area and a proximity area by a touch panel.

FIG. 7C is a third schematic diagram illustrating another example of detection of a contact area and a proximity area by a touch panel.

FIG. 7D is a fourth schematic diagram illustrating another example of detection of a contact area and a proximity area by a touch panel.

FIG. 7E is a fifth schematic diagram illustrating another example of detection of a contact area and a proximity area by a touch panel.

FIG. 7F is a sixth schematic diagram illustrating another example of detection of a contact area and a proximity area by a touch panel.

FIG. 8A is a first schematic diagram illustrating an example of the UI component.

FIG. 8B is a second schematic diagram illustrating an example of the UI component.

FIG. 8C is a third schematic diagram illustrating an example of the UI component.

FIG. 8D is a fourth schematic diagram illustrating an example of the UI component.

FIG. 8E is a fifth schematic diagram illustrating an example of the UI component.

FIG. 9 is a schematic diagram illustrating an example of overlap of a UI component, a contact area, and a proximity area.

FIG. 10A is a first schematic diagram illustrating an example of parallel translation.

FIG. 10B is a second schematic diagram illustrating an example of parallel translation.

FIG. 11 is a schematic diagram illustrating an example of line symmetry movement.

FIG. 12 is a schematic diagram illustrating an example of point symmetry movement.

FIG. 13 is a schematic diagram illustrating an example of rotation.

FIG. 14A is a first schematic diagram illustrating an example of reduction.

FIG. 14B is a second schematic diagram illustrating an example of reduction.

FIG. 15A is a first schematic diagram illustrating an example of expansion.

FIG. 15B is a second schematic diagram illustrating an example of expansion.

FIG. 16A is a first schematic diagram illustrating another example of rotation.

FIG. 16B is a second schematic diagram illustrating another example of rotation.

FIG. 16C is a third schematic diagram illustrating another example of rotation.

FIG. 17 is a schematic diagram illustrating another example of parallel translation.

FIG. 18A is a first schematic diagram illustrating another example of reduction and expansion.

FIG. 18B is a second schematic diagram illustrating another example of reduction and expansion.

FIG. 19A is a first schematic diagram illustrating an example of replica display.

FIG. 19B is a second schematic diagram illustrating an example of replica display.

FIG. 20 is a block diagram illustrating an internal configuration of an electronic apparatus according to a second embodiment of the present invention.

FIG. 21 is a block diagram illustrating an internal configuration of an electronic apparatus according to a third embodiment of the present invention.

FIG. 22 is a flowchart illustrating an operation of a control unit according to this embodiment.

FIG. 23 is a block diagram illustrating an internal configuration of an electronic apparatus according to a modification example of the embodiment.

FIG. 24A is a first arrangement diagram of a contact detection device, a proximity detection device and a display unit according to the modification example.

FIG. 24B is a second arrangement diagram of a contact detection device, a proximity detection device and a display unit according to the modification example.

### EMBODIMENT FOR CARRYING OUT THE INVENTION

### First Embodiment

Hereinafter, a first embodiment of the present invention will be described with reference to the drawings.

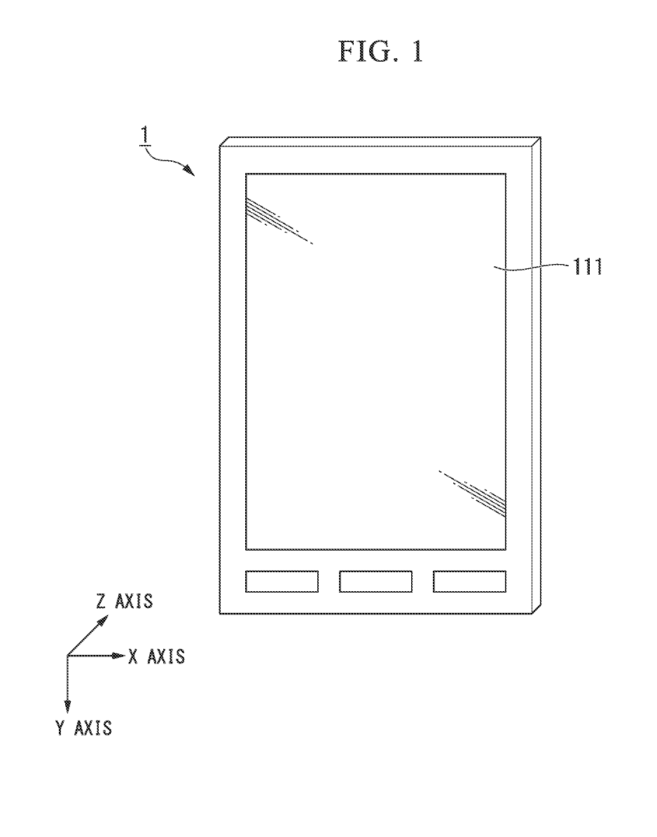

FIG. 1 is a surface view illustrating an appearance configuration of an electronic apparatus 1 according to the first embodiment of the present invention.

The electronic apparatus 1 is, for example, a multifunctional portable phone including a touch panel 111 provided on its surface. The electronic apparatus 1 may be another portable terminal device, a personal computer, or the like.

The touch panel 111 has both of a function of displaying an image, and a function of detecting a position in which a manipulation input is received. The touch panel 111 is also called a touch screen.

Accordingly, a user manipulates the electronic apparatus 1 by pressing a part of an image displayed on the touch panel 111 to cause the electronic apparatus 1 to execute a process corresponding to a pressed position.

In FIG. 1, an X axis, a Y axis, and a Z axis indicate directional axes of a horizontal direction, a vertical direction, and a front and back direction of the electronic apparatus 1. Directions of the X axis, the Y axis, and the Z axis are referred to as an X direction, a Y direction, and a Z direction, respectively.

### (Internal Configuration of the Electronic Apparatus)

Next, an internal configuration of the electronic apparatus 1 will be described.

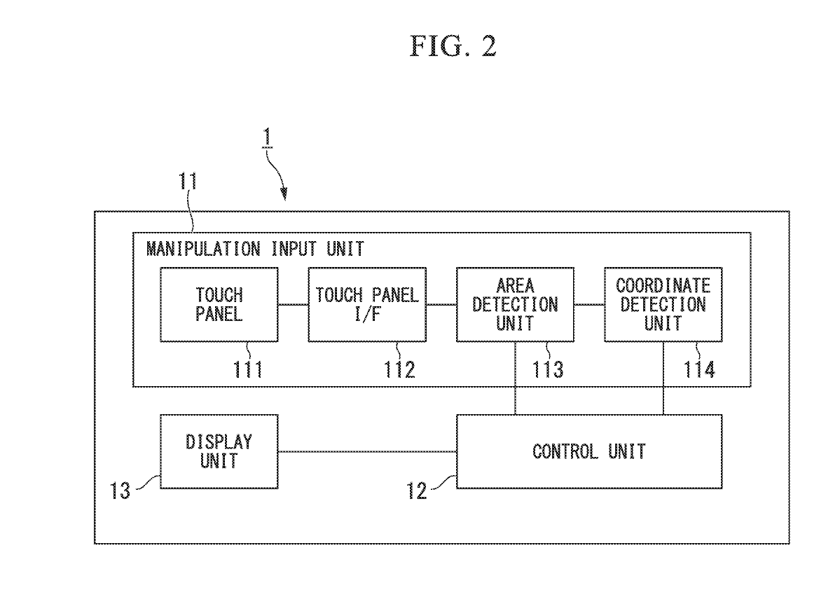

FIG. 2 is a schematic diagram illustrating an internal configuration of the electronic apparatus 1 according to an embodiment of the present invention.

The electronic apparatus 1 includes a manipulation input unit 11, a control unit 12, and a display unit 13.

The manipulation input unit 11 receives a manipulation input performed by a user on the touch panel 111, and outputs manipulation input information indicated by the received manipulation input to the control unit 12. Contact information indicating a contact area in which the user comes in contact with the touch panel 111 with a manipulation object such as a finger, proximity information indicating a proximity area in which the manipulation object is close to the touch panel 111, and a pointing coordinate (a contact position) that is a position representing the position in which the manipulation input is received are contained in the manipulation input information.

Therefore, the manipulation input unit 11 includes the touch panel 111, a touch panel I/F (interface) 112, an area detection unit 113 and a coordinate detection unit 114.

The touch panel 111 detects signals according to a contact state in which the manipulation object comes in contact with the touch panel for each coordinate, and a proximity state in which the manipulation object is close to the touch panel, and outputs the detected detection signal to the touch panel I/F 112. For example, a capacitive scheme for detecting capacitance (potential difference) generated between the manipulation object and a sensor may be used as one detection scheme for the touch panel 111, but the invention is not limited thereto. The touch panel 111 may be integrally configured with, for example, the display unit 13 to be described below. When the touch panel 111 is integrally configured with the display unit 13, the touch panel 111 may be formed of a transparent material. Accordingly, an image displayed by the display unit 13 becomes visible to the user through the touch panel 111.

The touch panel I/F 112 receives or outputs a signal from or to the touch panel 111. The touch panel I/F 112 outputs the detection signal input from the touch panel 111 to the area detection unit 113.

In addition, the touch panel I/F 112 changes sensitivity of the touch panel 111. The touch panel I/F 112 switches, for example, the sensitivity between standard sensitivity at which the detection signal indicating the contact area is mainly output in the touch panel 111 and high sensitivity, which is higher than the standard sensitivity, at which a detection signal indicating each of the contact area and the proximity area is output. The contact area and the proximity area will be described below. The touch panel I/F 112 may set the high sensitivity from operation start of the electronic apparatus 1. In addition, the touch panel I/F 112 may determine sensitivity at the time of operation start of the electronic apparatus 1 as the standard sensitivity, switch the sensitivity to the high sensitivity after the area detection unit 113 detects the contact area, and then switch the sensitivity to the standard sensitivity after a period of time in which the area detection unit 113 does not detect the contact area reaches a predetermined period of time (for example, 10 seconds). When the sensitivity increases, power consumption increases. Accordingly, in order to save power consumption in comparison with the case in which the sensitivity is always high, the sensitivity is increased only when the manipulation input is received and division of the contact area and the proximity area to be described below is necessary.

In order to change the sensitivity of the touch panel 111, for example, a space resolution of a sensor (not illustrated) included in the touch panel 111 is changed. In other words, in order to realize the standard sensitivity, an applied voltage is adjusted so that the sensor of the touch panel 111 outputs the detection signal indicating the contact area in which the manipulation object mainly comes in contact with the touch panel 111. On the other hand, in order to realize the high sensitivity, the applied voltage is adjusted so that the sensor of the touch panel 111 outputs a detection signal indicating not only the contact area in which the manipulation object comes in contact with the touch panel 111, but also an area (that is, the proximity area) in which the manipulation object is close to the sensor, for example at a distance within about 10 mm. In addition, the high sensitivity can be realized by lengthening a scanning time interval of the touch panel 111 in comparison with the case of the standard sensitivity. In this case, time resolution is degraded. Accordingly, the detection signal according to the proximity area as well as the contact area is input from the touch panel 111 to the touch panel I/F 112.

The area detection unit 113 detects the contact area in which the manipulation object comes in contact with the surface of the touch panel 111 and the proximity area in which the manipulation object is close to the surface of the touch panel 111 based on the detection signal input from the touch panel I/F 112. As described above, the contact area and the proximity area are detected together when the sensitivity of the touch panel 111 is the high sensitivity. When the sensitivity of the touch panel 111 is the standard sensitivity, the contact area is mainly detected, and the proximity area is not significantly detected. The area detection unit 113 outputs contact information indicating the detected contact area and proximity information indicating the proximity area to the control unit 12. The area detection unit 113 outputs the contact information to the coordinate detection unit 114. In the area detection unit 113, as described above, a contact area detection unit that detects the contact area and a proximity area detection unit that detects the proximity area may be integrally configured, or the contact area detection unit and the proximity area detection unit may be separately configured. An example in which the contact area and the proximity area are detected will be described below.

The coordinate detection unit 114 detects a pointing coordinate based on the contact area indicated by the contact information input from the area detection unit 113. Here, the coordinate detection unit 114 detects, as the pointing coordinate, for example, a center point that is a representative point of the contact area. The coordinate detection unit 114 outputs the detected pointing coordinate to the control unit 12.

The control unit 12 executes control and a process of each unit in the electronic apparatus 1 to realize a function as the electronic apparatus 1, and outputs a generated image signal to the display unit 13. The control unit 12 may include, for example, a CPU (Central processing Unit), a main storage device (RAM: Random Access Memory), and an auxiliary storage device (for example, a flash memory or a hard disk). Here, the control unit 12 reads screen component data indicating the screen component stored in advance, and determines a display position in which the screen component is displayed, for example, based on the pointing coordinate input from the coordinate detection unit 114, and the contact area information and the proximity area information input from the area detection unit 113. A configuration of the control unit 12 will be described below.

The display unit 13 displays an image based on the image signal input from the control unit 12. The display unit 13 is, for example, a liquid crystal display panel, and is integrally configured so that an image display surface is covered with the touch panel 111. In addition, the display unit 13 may be configured as an entity separate from the touch panel 111.

### (Configuration of the Control Unit)

Next, a configuration of the control unit 12 will be described. The same configurations as those in FIG. 2 are denoted with the same reference signs.

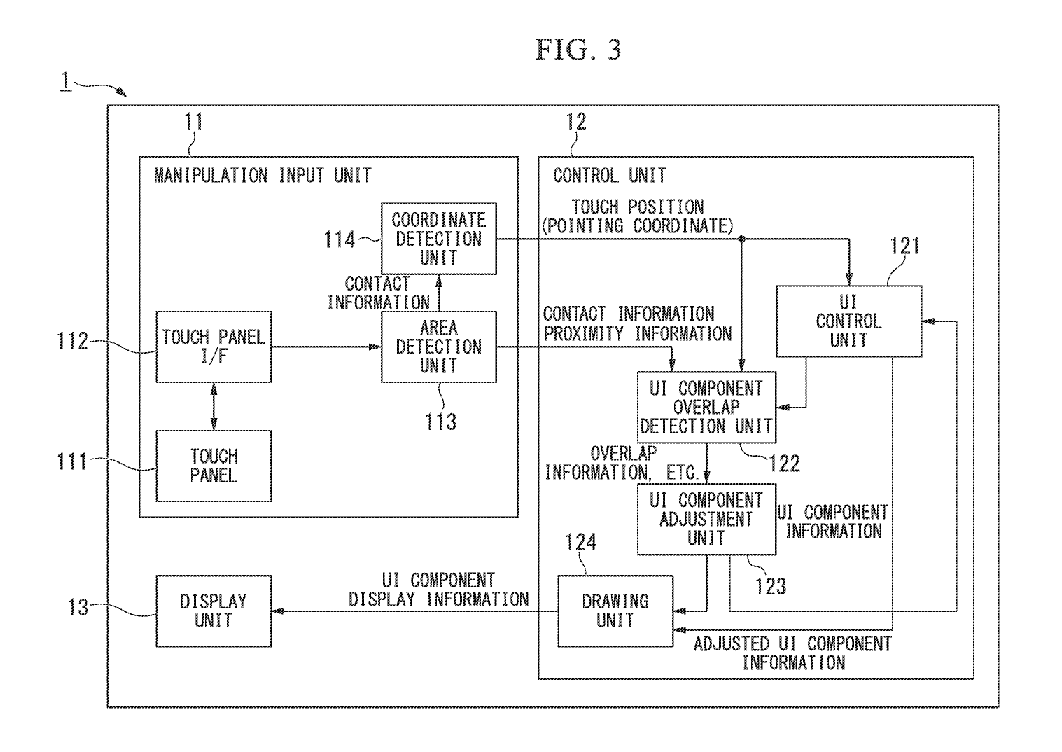

FIG. 3 is a block diagram illustrating a configuration of the manipulation input unit 11, the control unit 12 and the display unit 13, and a combination relationship among the units according to this embodiment. The configuration of the manipulation input unit 11 has already been described using FIG. 2.

The control unit 12 includes a UI control unit 121, a UI component overlap detection unit 122, a UI component adjustment unit 123, and a drawing unit 124.

When the pointing coordinate is input from the coordinate detection unit 114, the UI control unit 121 reads UI (User Interface) component information stored in a storage unit (not illustrated) included in the own unit in advance. The UI component information is information indicating the UI component, and the UI component is another name for a screen component constituting a screen. The UI component is also known as a GUI (Graphic User Interface) component. An example of the UI component will be described below. The UI control unit 121 assigns the pointing coordinate input from the coordinate detection unit 114 as element information (display position) of the read UI component information. The UI control unit 121 outputs the UI component information to which the pointing coordinate has been assigned to the UI component overlap detection unit 122.

However, when the input pointing coordinate is in a predetermined range from the pointing coordinate input when the UI component information is read immediately before, the UI control unit 121 does not read the UI component information.

In addition, when the UI component information is input from the UI component adjustment unit 123, UI component display information (not adjusted), or element information (display data) of the UI component information read immediately before, is replaced and updated with the input UI component display information (adjusted) of the element information of the UI component information. The UI control unit 121 outputs the updated UI component information to the UI component overlap detection unit 122.

In addition, when the pointing coordinate is not input from the coordinate detection unit 114 or when the UI component information is not read, that is, when there is no change in UI component display information, the UI control unit 121 outputs the generated or updated original UI component display information to the drawing unit 124.

The UI component overlap detection unit 122 integrates the contact area indicated by the contact information input from the area detection unit 113 and the proximity area indicated by the proximity area to generate integrated detection area information indicating an integrated detection area. The UI component overlap detection unit 122 extracts the UI component display information from the UI component information input from the UI control unit 121. The UI component overlap detection unit 122 detects an overlap area that is an area that overlaps the integrated detection area in the UI component display area (screen component area) indicated by the extracted UI component display information. When the UI component display area is identified, the pointing coordinate input from the coordinate detection unit 114 may be used in some types of UI components. The UI component overlap detection unit 122 may indicate the detected overlap area using binary data for each pixel or may indicate the detected overlap area using polygon data obtained by approximating a shape of the area. The UI component overlap detection unit 122 generates overlap area information indicating the detected overlap area and adds the generated overlap area information to the UI component information. The UI component overlap detection unit 122 outputs the UI component information to which the overlap area information has been added and the integrated detection area information to the UI component adjustment unit 123. An example of the overlap area will be described below.

The UI component adjustment unit 123 extracts the overlap area information and the UI component display information from the UI component information input from the UI component overlap detection unit 122. The UI component adjustment unit 123 adjusts the arrangement of the UI component display area indicated by the extracted UI component display information in a predetermined aspect so that the overlap area indicated by the extracted overlap area information becomes smaller. The case in which the overlap area becomes smaller includes a case in which the overlap area is smaller than an original overlap area, and a case in which an overlap area is removed. The arrangement of the UI component display area indicates a size, a shape, a position, or a direction of the UI component display area, or any combination thereof. In the following description, the adjustment of the arrangement of the UI component display area may be referred to simply as adjustment. When the overlap area does not become small despite the adjustment, or when an overlap ratio is smaller than a predetermined size (for example, 20%), the UI component adjustment unit 123 may not adjust the arrangement of the UI component display area. The overlap ratio is a ratio of a size (for example, an area) of the overlap area to an area of the display area of the UI component. An example in which the arrangement of the UI component display area is adjusted will be described below.

The UI component adjustment unit 123 adds the UI component display information indicating the adjusted UI component display area to the UI component information and outputs the UI component information to which the UI component display information has been added, to the drawing unit 124 and the UI control unit 121. When the arrangement of the UI component display area is not adjusted, the UI component adjustment unit 123 outputs the input UI component display information to the drawing unit 124 and the UI control unit 121.

The drawing unit 124 superimposes an image of the UI component indicated by the UI component display information input from the UI control unit 121 or the UI component adjustment unit 123 on an application image indicated by an image signal input from an application execution unit (not illustrated) that executes another application. The drawing unit 124 outputs a UI component display image signal indicating an overlap image to the display unit 13.

The display unit 13 displays the UI component display image based on the UI component display image signal input from the drawing unit 124.

### (Process of the Control Unit)

Next, a process in the control unit 12 according to this embodiment will be described.

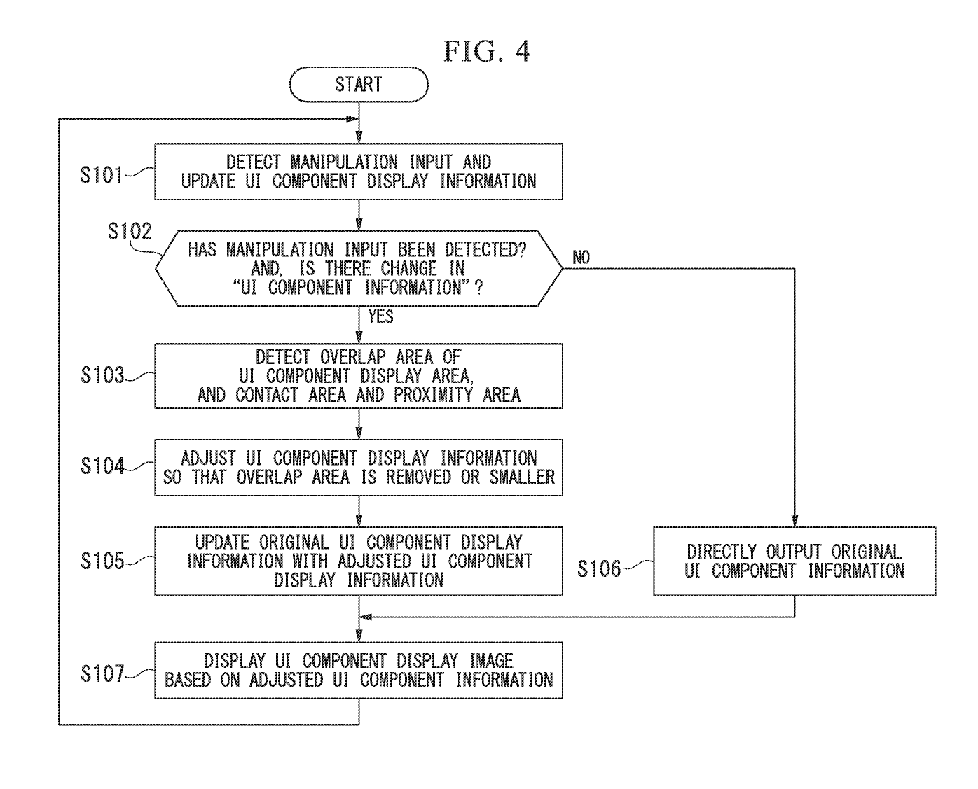

FIG. 4 is a flowchart illustrating a process in the control unit 12 according to this embodiment.

(Step S101) The pointing coordinate is input from the coordinate detection unit 114 to the UI control unit 121. Accordingly, the manipulation input (touch manipulation) by the user is detected. The UI control unit 121 adds the input pointing coordinate to the UI component information read from the storage unit, and updates the UI component information. The process then proceeds to step S102.

(Step S102) The UI control unit 121 detects the manipulation input and determines whether there has been a change in UI component information. When the manipulation input is detected and it is determined that there has been a change in UI component information (YES in step S102), the process proceeds to step S103. When the manipulation input is not detected or it is determined that there has not been a change in UI component information (NO in step S102), the process proceeds to step S106.

(Step S103) The UI component overlap detection unit 122 detects the overlap area of the UI component display area indicated by the UI component information input from the UI control unit 121 and the integrated detection area. The integrated detection area is an area resulting from integration of the contact area indicated by the contact information input from the area detection unit 113 and the proximity area indicated by the proximity area. The UI component overlap detection unit 122 adds the overlap area information indicating the detected overlap area to the input UI component information and outputs resultant information to the UI component adjustment unit 123. The process then proceeds to step S104.

(Step S104) The UI component adjustment unit 123 extracts the overlap area information and the UI component display information from the UI component information input from the UI component overlap detection unit 122. The UI component adjustment unit 123 adjusts the arrangement of the UI component display area indicated by the input UI component information so that the overlap area indicated by the overlap area information is removed or smaller. The UI component adjustment unit 123 adds the UI component display information indicating the adjusted UI component display area to the UI component information and outputs resultant information to the drawing unit 124 and the UI control unit 121. The process then proceeds to step S105.

(Step S105) The UI control unit 121 the UI control unit 121 replaces and updates original UI component display information (not adjusted) as element information (display data) of the UI component information read immediately before with the UI component display information (adjusted) of the element information of the input UI component information. The process then proceeds to step S107.

(Step S106) The UI control unit 121 directly outputs the original UI component information to the drawing unit 124. The process then proceeds to step S107.

(Step S107) The drawing unit 124 superimposes the image of the UI component indicated by the UI component display information included in the UI component information input from the UI control unit 121 or the UI component adjustment unit 123 on the input application image. The drawing unit 124 outputs a UI component display image signal indicating the superimposed image to the display unit 13. Accordingly, the display unit 13 displays a UI component display image based on the UI component display image signal input from the drawing unit 124. The process then returns to step S101 and a series of processes are repeated at predetermined time intervals (for example, 1/32 second).

### (Example of the Screen Display and the Detection Area)

Next, an example of the screen display and the detection area displayed by the display unit 13 will be described.

FIGS. 5A and 5B are schematic diagrams illustrating an example of the screen display and the detection area.

FIG. 5A illustrates that the touch panel 111 displays UI components U1 and U2 in response to contact of manipulation objects X1 and X2. Meanwhile, FIG. 5B illustrates a contact area Y1 in which the manipulation unit X1 comes in contact with the touch panel 111, and a proximity area Z1 in which the manipulation object X1 is close to the touch panel 111.

In addition, FIG. 5B illustrates a contact area Y2 in which a manipulation unit X2 comes in contact with the touch panel 111, and a proximity area Z2 in which the manipulation object X2 is close to the touch panel 111. An area that is a sum of the contact area Y1 and the proximity area Z1 is an integrated detection area related to the manipulation object X1, and an area that is a sum of the contact area Y2 and the proximity area Z2 is an integrated detection area related to the manipulation object X2. Areas in which the UI components U1 and U2 are displayed, that is, UI component display areas, are indicated by respective dashed lines. In the example illustrated in FIG. 5B, it is shown that the UI component display areas related to the UI components U1 and U2 do not overlap the integrated detection areas of the respective UI components U1 and U2.

In addition, when there are a plurality of UI components that are displayed as illustrated in FIGS. 5A and 5B, the UI component adjustment unit 123 may also adjust positions or arrangements of the respective UI components so that the display areas of the UI components do not overlap one another.

### (Example of Detection of the Contact Area and the Proximity Area)

Next, an example of detection of the contact area and the detection area will be described.

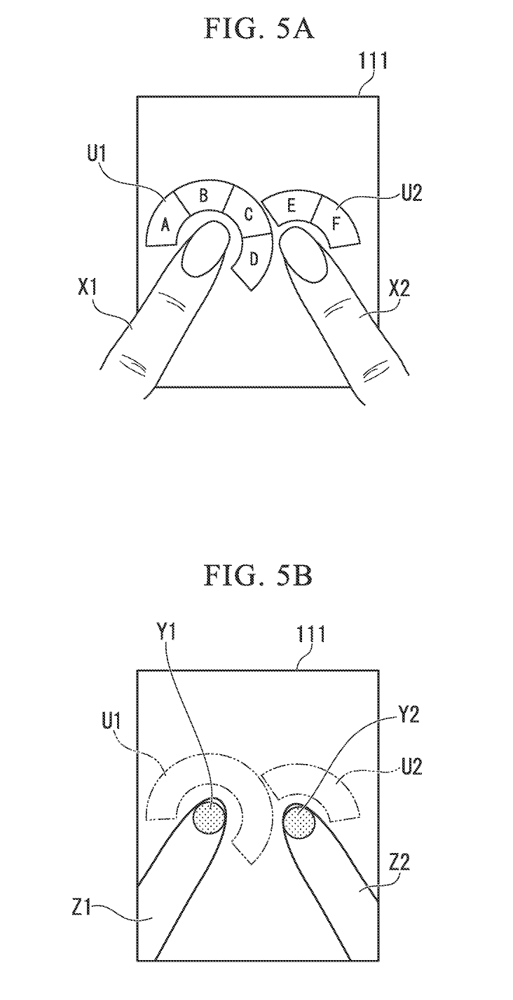

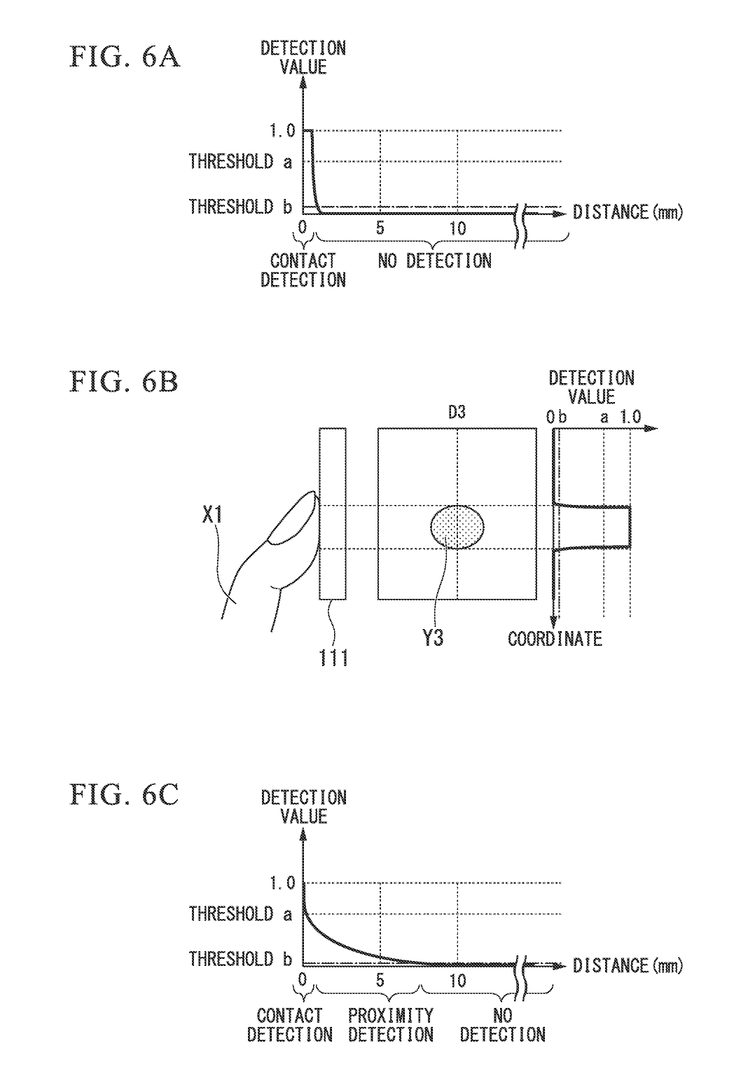

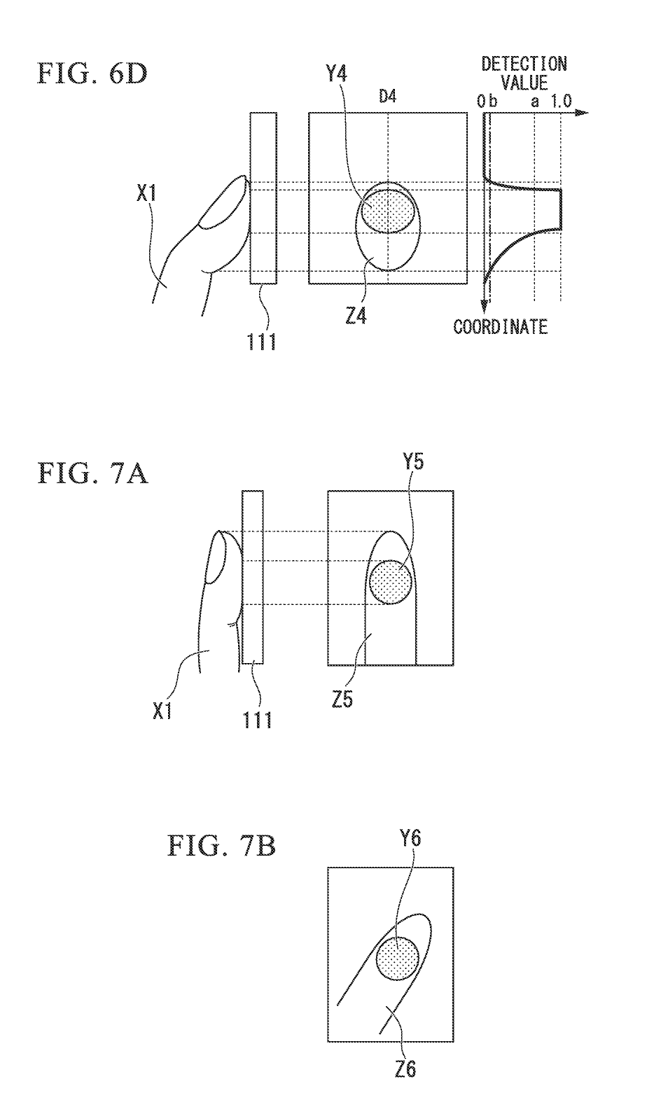

FIGS. 6A to 6D are schematic diagrams illustrating one example of detection of the contact area and the proximity area by the touch panel 111. FIG. 6A is a diagram illustrating an example of a detection value when the sensitivity of the touch panel 111 is the standard sensitivity. In FIG. 6A, a vertical axis indicates a detection value resulting from standardization with a detection value in the contact area being 1.0, and a horizontal axis indicates a distance in a normal direction (Z direction) from the surface of the touch panel 111 from one point in the contact area. In FIG. 6A, the detection value is about 1.0 when the distance is within 1.0 mm, but the detection value is suddenly reduced to 0 when the distance reaches 1.0 mm. When the distance exceeds 1.0 mm, the detection value remains 0. The area detection unit 113 determines an area in which the detection value exceeds a threshold a to be the contact area, and determines an area in which the detection value exceeds a threshold b and is equal to or smaller than the threshold a to be the proximity area. The threshold a is a predetermined real number (for example, 0.8) closer to 1 than 0, and the threshold b is a predetermined real number (for example, 0.2) closer to 0 than 1. In the example illustrated in FIG. 6A, the area in which the distance ranges from 0 to 1.0 mm is the contact area in which the contact of the manipulation object is detected, and the area in which the distance exceeds 1.0 mm is neither the contact area nor the proximity area, but a non-contact area. Thus, when the sensitivity of the touch panel 111 is the standard sensitivity, the proximity area is hardly detected.

A left column of FIG. 6B illustrates an example in which the manipulation object X1 comes in contact with the surface of the touch panel 111 when the sensitivity of the touch panel 111 is the standard sensitivity. A middle column of FIG. 6B illustrates a contact area Y3 detected by the area detection unit 113 in the surface of the touch panel 111. A right column of FIG. 6B indicates a detection value from the touch panel 111. In the right column of FIG. 6B, a horizontal axis indicates the detection value, and a vertical axis indicates a coordinate along a line D3 in the middle column of FIG. 6B. Even in the right column of FIG. 6B, the detection value is about 0 in both ends of the line D3, and about 1 in an intermediate part of the line D3. Accordingly, as illustrated in the middle column of FIG. 6B, the contact area Y3 in which the manipulation object X1 comes in contact with the touch panel 111 is detected, whereas the proximity area is hardly detected.

The left column of FIG. 6B illustrates an example in which the manipulation object X1 (for example, an index finger of the user) comes in contact with the surface of the touch panel 111 when the sensitivity of the touch panel 111 is the standard sensitivity.

FIG. 6C is a diagram illustrating an example of the detection value when the sensitivity of the touch panel 111 is the high sensitivity. In FIG. 6C, a vertical axis indicates the detection value, and a horizontal axis indicates a distance in a normal direction (Z direction) from the surface of the touch panel 111 from one point in the contact area. In FIG. 6C, the detection value is about 1.0 when the distance is within 1.0 mm, whereas the detection value is initially suddenly reduced near the threshold a, and gradually asymptotically approaches 0 when the distance exceeds 1.0 mm. When the distance reaches 7.0 mm, the detection value reaches the threshold b. In the example illustrated in FIG. 6C, an area in which the distance ranges from 0 to 1.0 mm is the contact area in which the contact of the manipulation object is detected, and an area in which the distance ranges from 1.0 mm to 7.0 mm is the proximity area in which the manipulation object is close to the touch panel 111. An area in which the distance exceeds 7.0 mm is neither the contact area nor the proximity area, but is a non-contact area. Thus, when the sensitivity of the touch panel 111 is the high sensitivity, the proximity area is detected.

A left column of FIG. 6D illustrates an example in which the manipulation object X1 comes in contact with the surface of the touch panel 111 when the sensitivity of the touch panel 111 is the high sensitivity. A middle column of FIG. 6D illustrates a contact area Y4 and a proximity area Z4 detected by the area detection unit 113 in the surface of the touch panel 111. A right column of FIG. 6D illustrates a detection value from the touch panel 111. In the right column of FIG. 6D, a horizontal axis indicates the detection value, and a vertical axis indicates a coordinate along a line D4 in the middle column of FIG. 6D. Even in the right column of FIG. 6D, the detection value becomes about 1 in an intermediate part of the line D4, but the detection value asymptotically approaches about 0 at both ends of the line D4. Accordingly, a contact area Y4 in which the manipulation object X1 comes in contact with the touch panel 111 and a proximity area Z4 around the contact area Y4 are detected, as illustrated in the middle column of FIG. 6D.

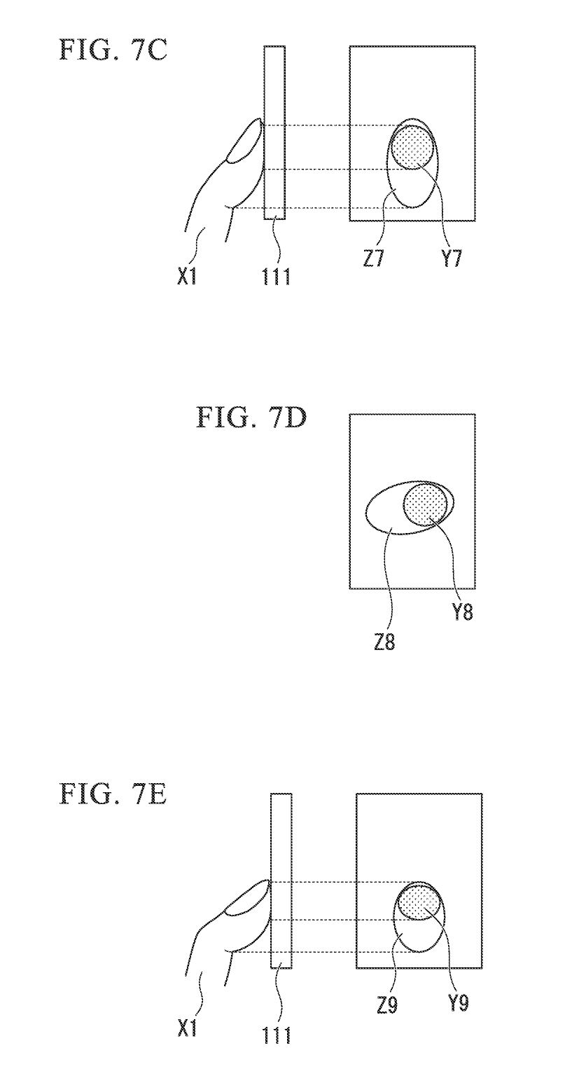

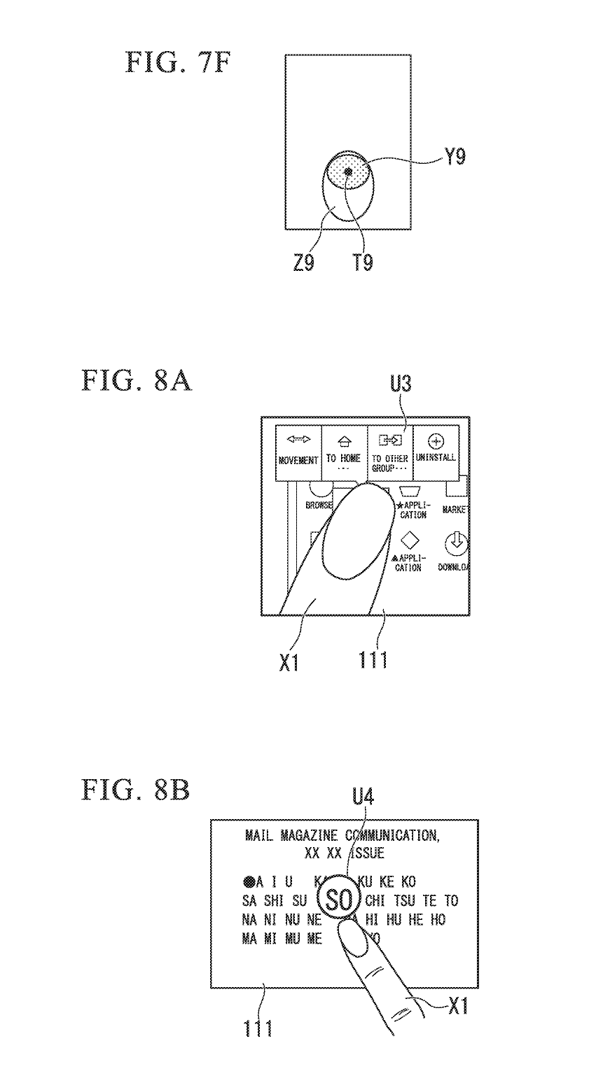

FIGS. 7A to 7F are schematic diagrams illustrating another example of detection of the contact area and the proximity area by the touch panel 111. In the example illustrated in FIGS. 7A to 7F, sensitivities of the touch panel 111 are all the high sensitivity.

A left column of FIG. 7A illustrates that a manipulation object X1 is placed substantially in parallel with and in a direction perpendicular to a surface of the touch panel 111, and an abdomen of a tip of the manipulation object X1 (for example, an index finger of a user) comes in contact with the surface. A right column of FIG. 7A illustrates a contact area Y5 and a proximity area Z5 detected in the case shown in the left column. The contact area Y5 is an area in which the abdomen of the tip of the manipulation object X1 comes in contact with the touch panel 111, and the proximity area Z5 is an entire area in which the manipulation object X1 faces the touch panel 111.

FIG. 7B illustrates a contact area Y6 and a proximity area Z6 detected when the manipulation object X1 is substantially placed in parallel with and in an upper right direction from the surface of the touch panel 111, and the abdomen of the tip of the manipulation object X1 comes in contact with the surface. Even in this case, the contact area Y6 is an area in which the abdomen of the tip of the manipulation object X1 comes in contact with the touch panel 111, and the proximity area Z6 is an entire area in which the manipulation object X1 faces the touch panel 111.

A left column of FIG. 7C illustrates that the manipulation object X1 is placed in a direction perpendicular to the surface of the touch panel 111, and the tip of the manipulation object X1 comes in contact with the surface. A right column of FIG. 7C illustrates a contact area Y7 and a proximity area Z7 detected in the case shown on the left column. The contact area Y7 is an area in which the abdomen of the tip of the manipulation object X1 comes in contact with the touch panel 111, and the proximity area Z7 is an area close to the tip of the manipulation object X1, which is an area facing the touch panel 111.

FIG. 7D illustrates a contact area Y8 and a proximity area Z8 detected when a manipulation object X1 is placed in an upper right direction of the touch panel 111, and the tip of the manipulation object X1 comes in contact with the touch panel 111. Even in this case, a contact area Y8 is the tip of the manipulation object X1 actually coming in contact with the touch panel 111, and a proximity area Z8 is the area close to the tip of the manipulation object X1, which is an area facing the touch panel 111.

A left column of FIG. 7E illustrates that the manipulation object X1 is placed in a direction perpendicular to the surface of the touch panel 111, and the tip of the manipulation object X1 comes in contact with the surface. A right column of FIG. 7E illustrates a contact area Y9 and a proximity area Z9 detected in the case shown on the left column. The contact area Y9 is an area in which the abdomen of the tip of the manipulation object X1 comes in contact with the touch panel 111, and the proximity area Z9 is an area close to the tip of the manipulation object X1, which is an area facing the touch panel 111. The contact area Y9 and the proximity area Z9 have a smaller size than the contact area Y8 and the proximity area Z8.

FIG. 7F illustrates an example of calculation of a pointing coordinate, that is, a touch position T9. The example illustrated in FIG. 7F shows that the coordinate detection unit 114 calculates a center point of the contact area Y9 as the touch position T9 without consideration of the proximity area Z9. Accordingly, even when the sensitivity of the touch panel 111 is the high sensitivity, the coordinate intended by the user can be determined based on the contact area Y9 in which the manipulation object X1 actually comes in contact with the touch panel without being affected by the proximity area Z9.

### (Example of the UI Component)

Next, an example of the UI component will be described.

Types of the UI component greatly include two types: a popup UI component and a normal UI component. The popup UI component is a UI component displayed in a predetermined position from a pointing coordinate pointed to by a manipulation input, which is triggered by reception of the manipulation input, as in the case in which the manipulation object comes in contact with the touch panel 111. The popup UI components include, for example, a pop-up menu, and a magnifying glass. The normal UI component is a UI component that is displayed irrespective of whether the manipulation input is received. The normal UI components include, for example, an icon, a button, and a slider. Usually, a type of UI component that is used is determined in advance in an OS (Operating System) or application software that is operating.

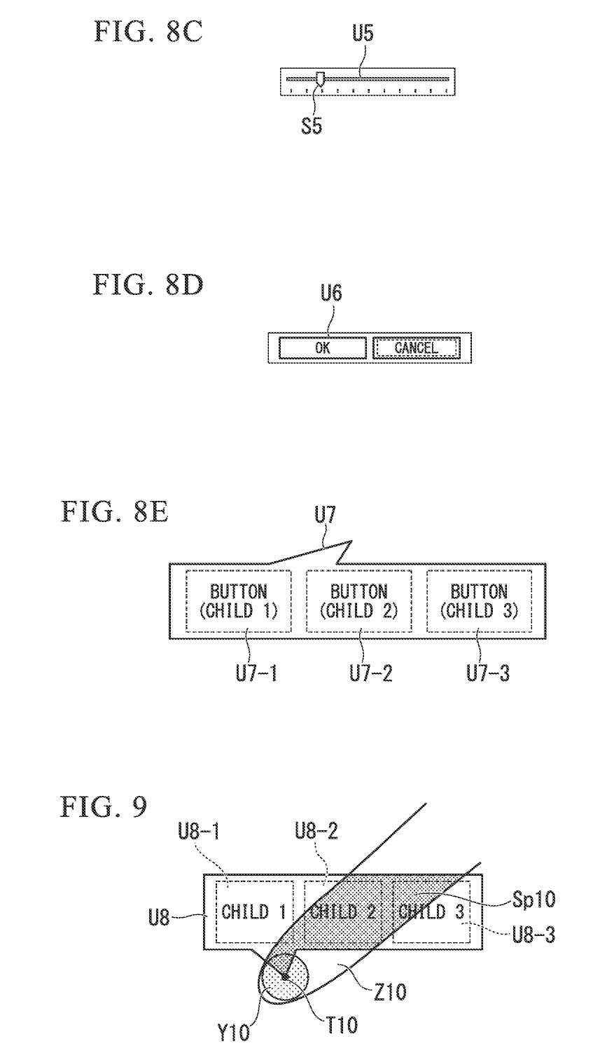

FIGS. 8A to 8E are schematic diagrams illustrating an example of the UI component.

FIG. 8A illustrates a pop-up menu U3 as an example of the UI component. The pop-up menu U3 is mainly displayed immediately after it is detected that the manipulation object X1 comes in contact with the touch panel 111. The pop-up menu U3 displays one or a plurality of functions that can be manipulated. When all or a part of an area in which each function is displayed is pointed to by a manipulation input of the user, the electronic apparatus 1 executes a function corresponding to the area that is pointed to. In the example illustrated in FIG. 8A, a position in which the pop-up menu U3 is displayed is an upward position away from the contact area in which the manipulation object X1 comes in contact with the touch panel 111 by the predetermined distance.

FIG. 8B illustrates a magnifying glass U4 as an example of the UI component. The magnifying glass U4 displays content displayed in an area that overlaps the magnifying glass in the display area, in an enlarged manner. When the manipulation object X1 moves while coming in contact with the touch panel 111, a display area of the magnifying glass U4 correspondingly moves. In addition, when the manipulation object X1 is away from the touch panel 111, the magnifying glass U4 and the content displayed in an enlarged manner in its display area return to a display having an original size.

FIG. 8C illustrates a slider U5 as an example of the UI component. The slider U5 includes a knob S5 whose length in one of a horizontal direction and a vertical direction is greater than a length in the other direction (in the example illustrated in FIG. 8C, the length in the horizontal direction is greater than the length in the vertical direction).

FIG. 8D illustrates a button U6 as an example of the UI component. The button U6 includes one or a plurality of display areas, and letters or symbols (“OK” and “Cancel” in the example of FIG. 8D) for identifying each display area are displayed in the display area. Each display area, the letter or symbol, and an option in the application are associated. When all or a part of the display area is pointed to by the manipulation input of the user, the option related to the area that is pointed to is selected in the electronic apparatus 1.

FIG. 8E illustrates one configuration example of a pop-up menu U7. The pop-up menu U7 includes a rectangular area that is long in a horizontal direction or a vertical direction (in the example illustrated in FIG. 8E, long in the horizontal direction), and a triangular area. In the rectangular area, one or a plurality of (in the example illustrated in FIG. 8E, three) buttons for selected functions are displayed, and the respective buttons are identified by buttons U7-1 to U7-3. A notation called (parent) of the pop-up menu U7 and a notation called (child 1) of each button such as the button U7-1 in FIG. 8E are notations according to a master-servant relationship indicating that the pop-up menu U7 is a high level of the respective buttons U7-1 to U7-3. In addition, while the pop-up menu U7 is illustrated as having a shape resembling a balloon, the pop-up menu U7 may have any of other shapes such as a rectangle, a square with rounded corners, and an ellipse.

### (UI Component Information)

Next, the UI component information will be described. The UI component information is information indicating a type or a property of the UI component and is information generated for each UI component displayed on the display unit 13.

The UI component information includes, for example, the following element information (i1) to (i8): (i1) identification information (component name), (i2) a type, (i3) a state, (i4) adjustment conditions, (i5) a display position, (i6) a size (for example, a height in the vertical direction or a width in the horizontal direction), (i7) display data (for example, appearance data: a display character string, a letter color, a background color, a shape, a texture, and an image), and (i8) identification information of a lower UI component (sub UI component).

Here, (i1) the identification information is information for identifying individual UI components, such as an ID (Identification) number. (i2) The type is, for example, information indicating the pop-up menu, the magnifying glass, the slider, or the button described above. (i3) The state is, for example, information indicating whether a manipulation input is received or not (Enable/Disable), whether pressing is performed or not (On/Off), or a set value (in the case of the slider). (i4) Adjustment conditions are information indicating an aspect allowed as an aspect (for example, parallel translation or rotation to be described below) in which the display area is adjusted. (i5) Display position is information indicating a position representing the position in which the UI component is displayed, such as a coordinate at which a center of gravity is placed on the display unit 13. (i6) Size is information indicating a size at which the UI component is displayed as an image on the display unit 13, such as an area. The area displayed as an image on the display unit 13 corresponds to an area in which the touch panel 111 can receive a manipulation input. Specifically, the control unit 12 executes an operation corresponding to the UI component when it is determined that a touch position is included in this area. (i7) Display data is image data for displaying the UI component as an image on the display unit 13, that is, the UI component display image signal described above. (i8) Identification information of the lower UI component is information for identifying a UI component that is at a lower level than the own UI component when there is a master-servant relationship among UI components. For one UI component, there may be a plurality of lower UI components. For example, identification information of each of three buttons U7-1 to U7-3 is shown as identification information of the lower UI component related to the pop-up menu U7 illustrated in FIG. 8E.

Among the element information described above, the information on the adjustment of the display area, that is, the UI component display information, includes (i3) state, (i4) adjustment conditions, (i5) display position, (i6) size, (i7) display data, and (i8) identification information of the lower UI component. Here, an area in which an image of the UI component based on (i7) display data is displayed at (i6) size so that its representative point becomes (i5) display position corresponds to the UI component display area.

(Example of Overlap of the UI Component with the Contact Area and the Proximity Area)

Next, an example of overlap of the UI component with the contact area and the proximity area will be described in connection with an example of the UI component 8 (pop-up menu).

FIG. 9 is a schematic diagram illustrating an example of overlap of the UI component with the contact area and the proximity area.

In FIG. 9, the UI component U8 is a UI component having a master-servant relationship in which three UI components U8-1 to U8-3 are at a lower level. An area extending from the lower left to the upper right with respect to the UI component U8 is a proximity area Z10. A contact area Y10 is included at a tip of the proximity area Z10. FIG. 9 illustrates that the coordinate detection unit 114 determines a center point of the contact area Y10 to be a pointing coordinate (touch position T10). In this example, it is shown that the UI control unit 121 places a vertex of a triangle as a reference point of the UI component U8 at the pointing coordinate determined by the coordinate detection unit 114, and determines the UI component display area of the UI component U8 so that a longitudinal direction of a rectangular area is parallel to a horizontal direction. In addition, in FIG. 9, a filled area mainly included in the proximity area Z10 is an overlap area Sp10. The overlap area Sp10 is an area that overlaps an integrated detection area including the contact area Y10 and the proximity area Z10 in the UI component display area of the UI component U8, and is an area detected by the UI component overlap detection unit 122.

### (Example of Adjustment of the Arrangement of the UI Component Display Area)

Aspects in which the arrangement of the UI component display area is adjusted greatly include movement and deformation. The movement refers to changing a position without changing a shape. The movement includes, for example, parallel translation, line symmetry movement, and point symmetry movement. The deformation refers to changing the shape. The deformation and the movement may be performed at the same time. The deformation includes, for example, reduction, expansion, coordinate transformation based on linear mapping, and coordinate transformation based on quadratic mapping. In addition, in this embodiment, when coefficients related to the adjustment are different even though aspects are the same, the different coefficients may be treated as different aspects. For example, in the parallel translation, movement of ten pixels in a positive direction of an X axis and movement of five pixels in a negative direction of a Y axis may be treated as different aspects. Examples of such coefficients include coefficients such as a reduction rate in reduction, an expansion rate in expansion, and a slope or an intercept in coordinate transformation, in addition to a movement direction and a movement amount in the parallel translation.

The UI component adjustment unit 123 adjusts the arrangement of the UI component display area in an aspect shown in the adjustment conditions as element information of the UI component information for each UI component. In addition, when a plurality of aspects are shown in the adjustment conditions, the UI component adjustment unit 123 adjusts the arrangement of the UI component display area according to a priority shown in the adjustment conditions. Examples of the priority include a priority such as parallel translation, line symmetry movement, point symmetry movement, rotation, coordinate transformation based on linear mapping, a combination of the parallel translation and the line symmetry movement, a combination of the parallel translation and the point symmetry movement, and a combination of parallel translation and the rotation. When an overlapping rate related to the UI component after the adjustment based on a certain aspect (for example, the parallel translation) is zero or reaches a predetermined overlapping rate, the UI component adjustment unit 123 adopts UI component display information related to the UI component. The UI component adjustment unit 123 may not perform a process related to the adjustment in aspects according to a lower priority. The UI component adjustment unit 123 outputs the adopted UI component display information to the drawing unit 124 and the UI control unit 121.

In addition, when a plurality of aspects are shown in the adjustment conditions, the UI component adjustment unit 123 may adopt UI component display information after the adjustment in which an overlap rate is minimized or becomes zero. In this case, in the adjustment condition, the priority may not be determined. When there are a plurality of pieces of UI component display information after the adjustment in which the overlap rate is minimized or becomes zero, the UI component adjustment unit 123 may adopt any one of the pieces of UI component display information after the adjustment, such as one piece of UI component display information after the adjustment that has first been processed.

The UI component adjustment unit 123 adds the adopted UI component display information to the UI component information and outputs the UI component information to which the UI component display information has been added to the drawing unit 124 and the UI control unit 121.

In addition, in this embodiment, when the adjustment conditions are not determined as the element information of the UI component information, the UI component display area may be adjusted in a (default) aspect determined in an OS or an application in advance. In addition, the adjustment conditions may be determined to be different among types of UI components or may be determined to be the same among all the UI components.

Hereinafter, each example of parallel translation, line symmetry movement, point symmetry movement, rotation, reduction, and expansion will be described as an aspect in which the arrangement of the UI component display area is adjusted.

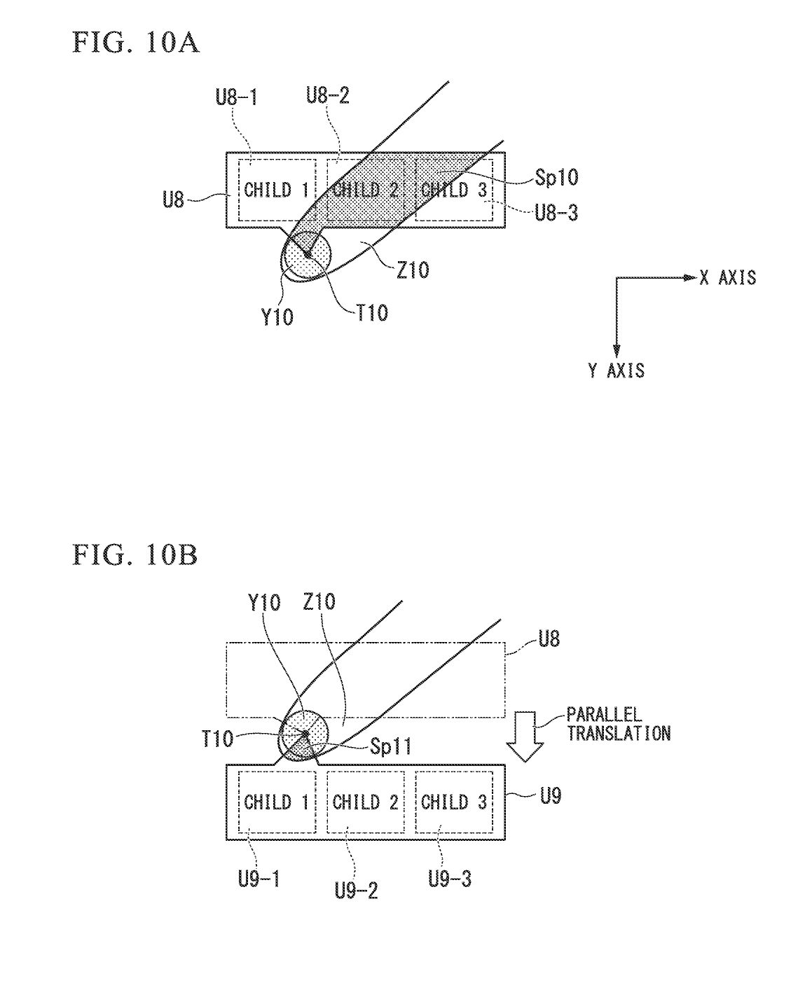

FIGS. 10A and 10B are schematic diagrams illustrating an example of the parallel translation. In FIGS. 10A and 10B, and FIGS. 11 to 18 to be described below, an X-axis direction is a horizontal direction, and a Y-axis direction is a vertical direction.

FIG. 10A illustrates a UI component U8 before adjustment (movement). A positional relationship among the configuration of the UI component U8, a contact area Y10, a proximity area Z10, an overlap area Sp10, and a touch position T10 is the same as that in FIG. 9.

FIG. 10B illustrates a UI component U9 that is a result of the UI component adjustment unit 123 parallel-translating the UI component U8 by a predetermined movement amount in the Y-axis direction, and illustrates an area of the UI component U8 before adjustment using a one-dot chain line. A Y-axis direction is a direction perpendicular to a longitudinal direction (in this example, an X-axis direction) of the UI component U8. Types and an arrangement of three UI components U9-1 to U9-3 included in the UI component U9 are the same as those of the UI components U8-1 to U8-3. However, a triangular area of the UI component U9 is displayed in the upper left of the UI component U9, and a vertex of the triangle is arranged in a touch position T10. An overlap area Sp11 is an area in which the UI component U9 and an integrated detection area including a contact area Y10 and a proximity area Z10 overlap, and is shown in a lower end of the proximity area Z10. In the example illustrated in FIGS. 10A and 10B, the overlap area Sp11 is smaller than the overlap area Sp10 before the adjustment.

In addition, in this embodiment, in the parallel translation, the UI component U8 may be moved in a negative direction of the Y-axis direction, in addition to the positive direction of the Y-axis direction, or may be moved in either a positive or negative direction of the X-axis direction.

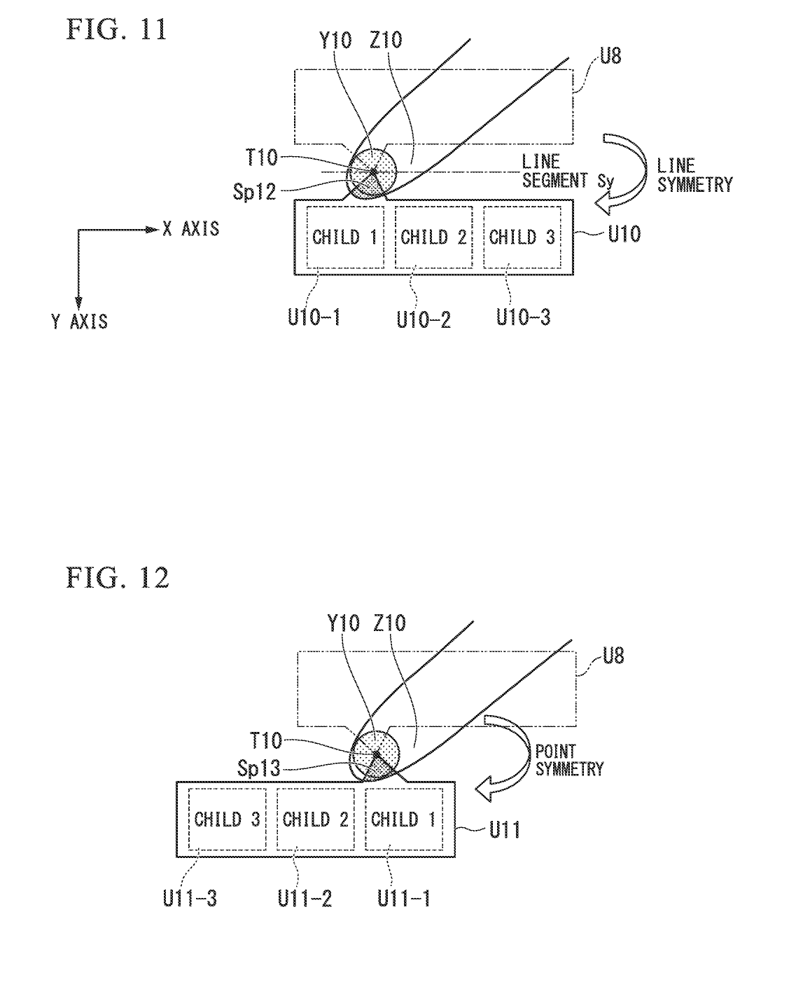

FIG. 11 is a schematic diagram illustrating an example of the line symmetry movement.

FIG. 11 illustrates a UI component U10 that is a result of the UI component adjustment unit 123 line symmetry-moving the UI component U8 using a line segment Sy as a symmetry axis, and illustrates an area of the UI component U8 before the adjustment using a two-dot chain line. The line segment Sy is a line segment extending in the same direction as a longitudinal direction (X-axis direction in this example) of the UI component U8, which passes through a touch position T. Types and an arrangement in a longitudinal direction of three UI components U10-1 to U10-3 included in the UI component U10 are the same as those of the UI components U8-1 to U8-3, but an arrangement in a direction perpendicular to such a direction is reversed. An overlap area Sp12 is an area in which the UI component U10 and an integrated detection area including a contact area Y10 and a proximity area Z10 overlap, and is shown in a lower end of the proximity area Z10. In the example illustrated in FIG. 11, the overlap area Sp12 is smaller than the overlap area Sp10.

In addition, in this embodiment, in the line symmetry movement, the line symmetry movement may be performed using a Y-axis direction as the symmetry axis, in addition to the X-axis direction.

FIG. 12 is a schematic diagram illustrating an example of the point symmetry movement.

FIG. 12 illustrates a UI component U11 that is a result of the UI component adjustment unit 123 moving the UI component U8 point-symmetrically using a touch position T10 as a symmetrical point, and illustrates an area of the UI component U8 before the adjustment using a two-dot chain line.

Types of three UI components U11-1 to U11-3 included in the UI component U11 are the same as those of the UI components U8-1 to U8-3, but an arrangement in the X-axis direction and the Y-axis direction is reversed. For example, in FIG. 12, the UI components U11-3, U11-2, and U11-2 are arranged sequentially from left to right. The UI components U11-3, U11-2, and U11-1 correspond to the UI components U8-3, U8-2, and U8-1 before the adjustment.

An overlap area Sp13 is an area in which the UI component U10 and an integrated detection area including a contact area Y10 and a proximity area Z10 overlap, and is shown in a lower end of the proximity area Z10. In the example illustrated in FIG. 12, the overlap area Sp13 is smaller than the overlap area Sp10.

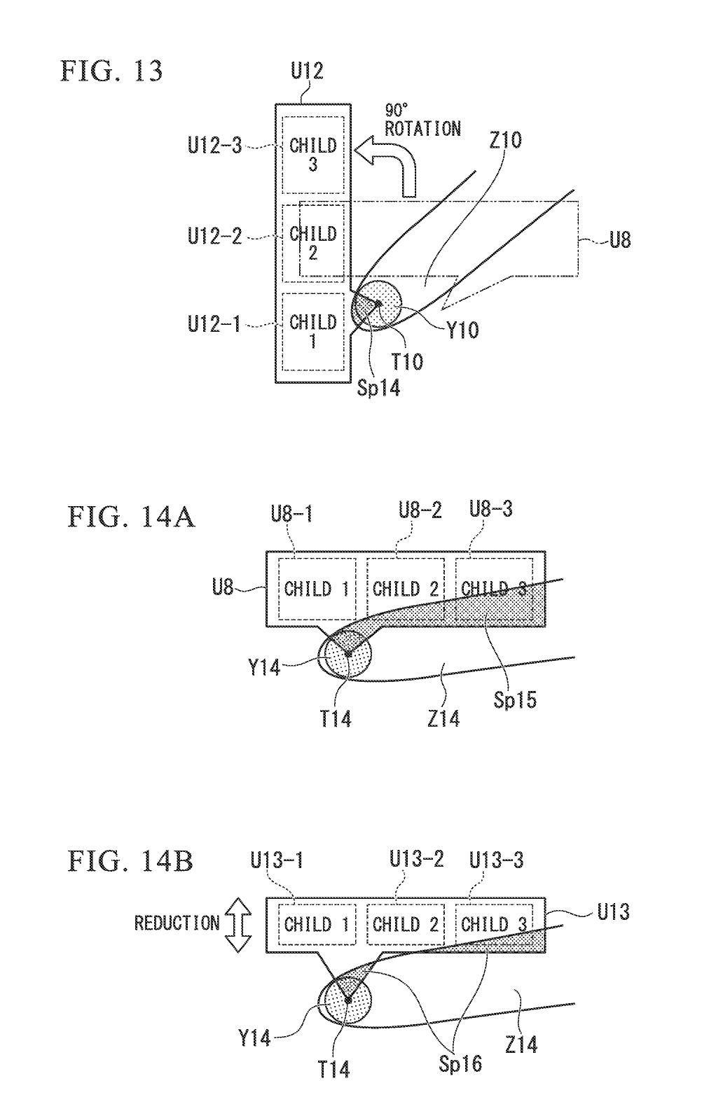

FIG. 13 is a schematic diagram illustrating an example of the rotation.

FIG. 13 illustrates a UI component U12 that is a result of the UI component adjustment unit 123 rotates the UI component U8 90° counterclockwise using a touch position T10 as a rotation axis, and illustrates an area of the UI component U8 before the adjustment using a two-dot chain line. Types of three UI components U12-1 to U12-3 included in the UI component U12 are the same as those of the UI components U8-1 to U8-3, but an arrangement thereof is also rotated 90° counterclockwise. For example, in FIG. 13, the UI components U12-3, U12-2, and U12-1 are arranged sequentially from top to bottom. The UI components U12-3, U12-2, and U12-1 correspond to the UI components U8-3, U8-2, and U8-1 before the adjustment, respectively.

An overlap area Sp14 is an area in which the UI component U10 and an integrated detection area including a contact area Y10 and a proximity area Z10 overlap, and is shown in a left end of the proximity area Z10. In the example illustrated in FIG. 13, the overlap area Sp14 is smaller than the overlap area Sp10.

In addition, in this embodiment, a rotation angle is not limited to 90° counterclockwise, and may be 180° or 270°.

FIGS. 14A and 14B are schematic diagrams illustrating an example of the reduction.

FIG. 14A illustrates the UI component U8 before adjustment (reduction). A configuration of the UI component U8 is the same as that illustrated in FIG. 9. An area extending horizontally in the lower right of the UI component U8 is a proximity area Z14, and a substantially circular area of a left tip of the proximity area Z14 is a contact area Y14. A center point of the contact area Y14 indicates a touch position T14. An upward filled area of the proximity area Z14 is an overlap area Sp15 in which the UI component U8 and an integrated detection area including the contact area Y14 and the proximity area Z14 overlap.

FIG. 14B illustrates a UI component U13 that is a result of the UI component adjustment unit 123 reducing the UI component U8 at a predetermined reduction rate in a Y-axis direction with a Y coordinate at an upper end fixed. The Y-axis direction is a direction perpendicular to a longitudinal direction (in this example, an X-axis direction) of the UI component U8. Types and an arrangement in the X-axis direction of three UI components U13-1 to-U13-3 included in the UI component U13 are the same as those of the UI components U8-1 to U8-3.

An overlap area Sp16 is an area in which the UI component U13 and an integrated detection area including the contact area Y14 and the proximity area Z14 overlap, and is shown divided into upward left and right areas of the proximity area Z14. In the example illustrated in FIGS. 14A and 14B, the overlap area Sp16 is smaller than the overlap area Sp15 before the adjustment.

In addition, in this embodiment, the reduction is not limited to the Y-axis direction and may be performed in the X-axis direction.

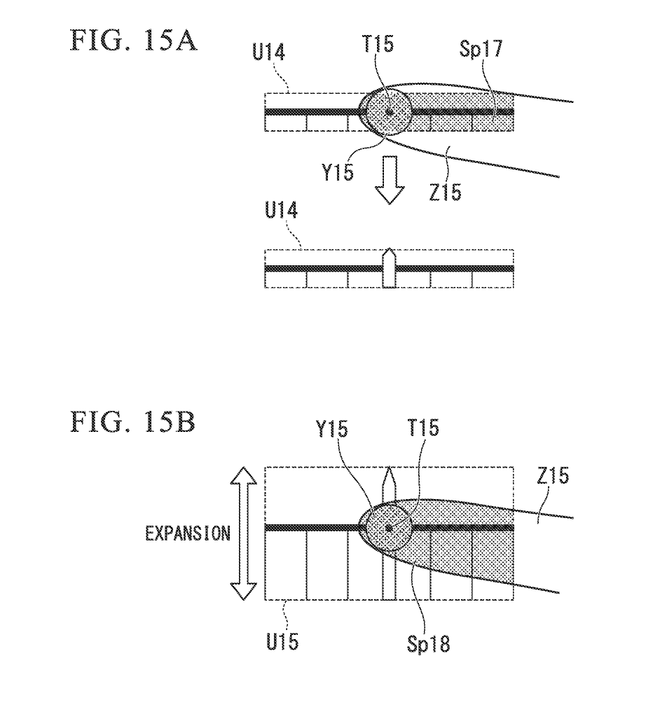

FIGS. 15A and 15B are schematic diagrams illustrating an example of the expansion.

FIG. 15A illustrates a UI component U14 before adjustment (expansion). The UI component U14 is an example of a slider. In an upper part of FIG. 15A, an area extending in a horizontal direction on the right side of the UI component U14 is a proximity area Z15, and a substantially circular area of a left tip of the proximity area Z15 is a contact area Y15. A center point of the contact area Y15 indicates a touch position T15. A filled area on the right side of the UI component U14 is an overlap area Sp17 in which the UI component U14 and an integrated detection area including the contact area Y15 and the proximity area Z15 overlap. An entire configuration of the UI component U14 is shown in a lower part indicated by an arrow.

FIG. 15B illustrates a UI component U15 that is a result of the UI component adjustment unit 123 expanding the UI component U14 in a Y-axis direction at a predetermined expansion rate based on the touch position T15. The Y-axis direction is a direction perpendicular to a longitudinal direction (in this example, an X-axis direction) of the UI component U14.

An overlap area Sp18 is an area in which the UI component U15 and an integrated detection area including the contact area Y15 and the proximity area Z15 overlap. In the example illustrated in FIGS. 15A and 15B, the overlap area Sp18 is larger than the overlap area Sp17 before the adjustment, but a ratio of the overlap area Sp18 to the display area of the UI component U15 is smaller than a ratio of the overlap area Sp17 to the display area of the UI component U14. This is because, in FIGS. 15A and 15B, the right side of the UI component U14 is covered with the proximity area Z15, whereas an upper right side and the lower right side of the UI component U15 appear without being covered with the proximity area Z15. Accordingly, the user can visually recognize that the UI component U14 is the slider, and recognize a knob portion that is a manipulation target. In addition, in this embodiment, the expansion is not limited to the Y-axis direction and may be performed in the X-axis direction.

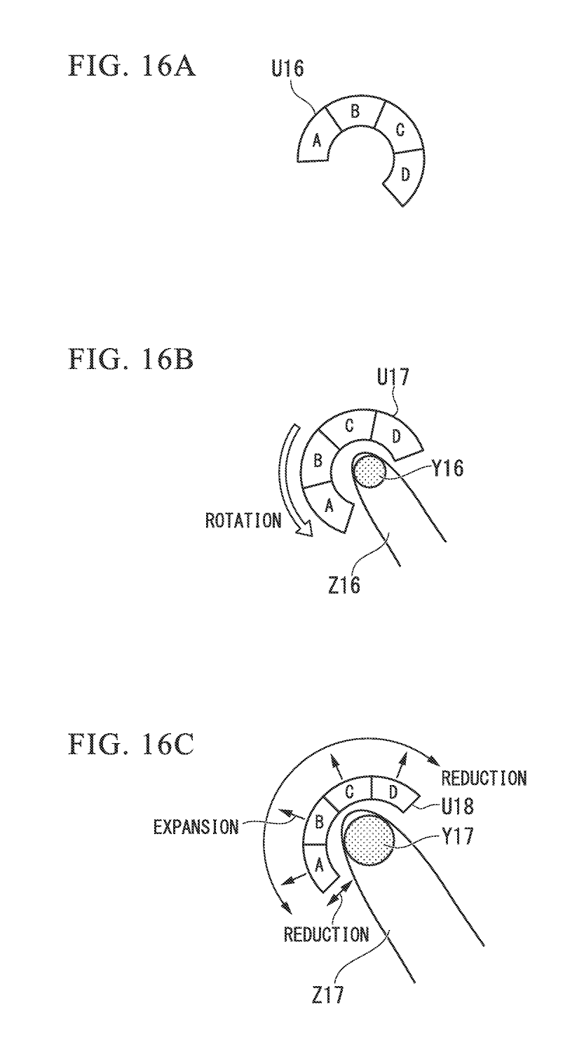

FIGS. 16A to 16C are schematic diagrams illustrating another example of the rotation.

FIG. 16A illustrates a UI component U16 before adjustment (rotation).

A display area of the UI component U17 is a pie-shaped area sandwiched between two concentric arcs.

FIG. 16B illustrates a UI component U17 that is a result of the UI component adjustment unit 123 rotating the UI component U16 counterclockwise at a predetermined rotation angle about a center point of the two arcs. An area whose tip is inserted into a central portion of the UI component U17 is a proximity area Z16. A substantially circular area of the tip of the proximity area Z16 is a contact area Y16. Accordingly, it is shown that the UI component adjustment unit 123 rotates the UI component U17 so that an integrated detection area including the contact area Y16 and the proximity area Z16 does not overlap the UI component U17.

FIG. 16C illustrates a UI component U18 that is a result of the UI component adjustment unit 123 rotating the UI component U16 counterclockwise at a predetermined rotation angle about the center point of the arc and reducing a width in an angle direction and a width in a radial direction. An area whose tip is inserted into a central portion of the UI component U18 is a proximity area Z17. A substantially circular area of the tip of the proximity area Z17 is a contact area Y17. A width of the proximity area Z17 is greater than the width of the proximity area Z16. Accordingly, it is shown that the UI component adjustment unit 123 rotates a display area of the UI component U16 so that an integrated detection area including the contact area Y17 and the proximity area Z17 does not overlap the UI component, and reduces the width in the angle direction and the width in the radial direction. In addition, the UI component adjustment unit 123 may expand the display area of the UI component U16 in the radial direction so that the integrated detection area including the contact area Y17 and the proximity area Z17 does not overlap the UI component.

FIG. 17 is a schematic diagram illustrating another example of the parallel translation.

In FIG. 17, the UI component U16 before adjustment (movement) is indicated by a dashed line. An area whose tip is inserted into a central portion of the UI component U16 is a proximity area Z18. A substantially circular area of the tip of the proximity area Z18 is a contact area Y18. Here, the UI component adjustment unit 123 extracts an outer edge of the proximity area Z18 using an existing edge extraction process, and calculates a center line Cz in a longitudinal direction of the extracted outer edge. When the UI component adjustment unit 123 calculates the center line Cz, the UI component adjustment unit 123, for example, may smooth a shape of the extracted outer edge and calculate a main axis of the smoothed outer edge as the center line Cz. Here, the UI component adjustment unit 123, for example, moves the UI component display area related to the UI component U19 to a position moved by a predetermined movement amount in a vertical direction from the calculated center line Cz. Since a direction of this center line Cz approximates a direction in which the manipulation object is placed on the touch panel 111, the position of the UI component U19 can be adjusted to avoid the direction to which the manipulation object is directed.

Here, the direction in which the UI component display area related to the UI component U19 is moved is not limited to the direction perpendicular to the center line Cz described above. The direction may be a direction away from the UI component display area related to the UI component U19 and the integrated detection area including the contact area Y18 and the proximity area Z18, that is, a direction in which an overlap area of the UI component display area and the integrated detection area is removed or reduced. For example, the direction may be a direction for avoiding the direction in which the manipulation object is directed, that is, a direction different from the line segment of the center line Cz included in the integrated detection area. In addition, the direction may be the same direction as the line segment of the center line Cz or may be a direction completely opposite to the direction in which the manipulation object is directed.

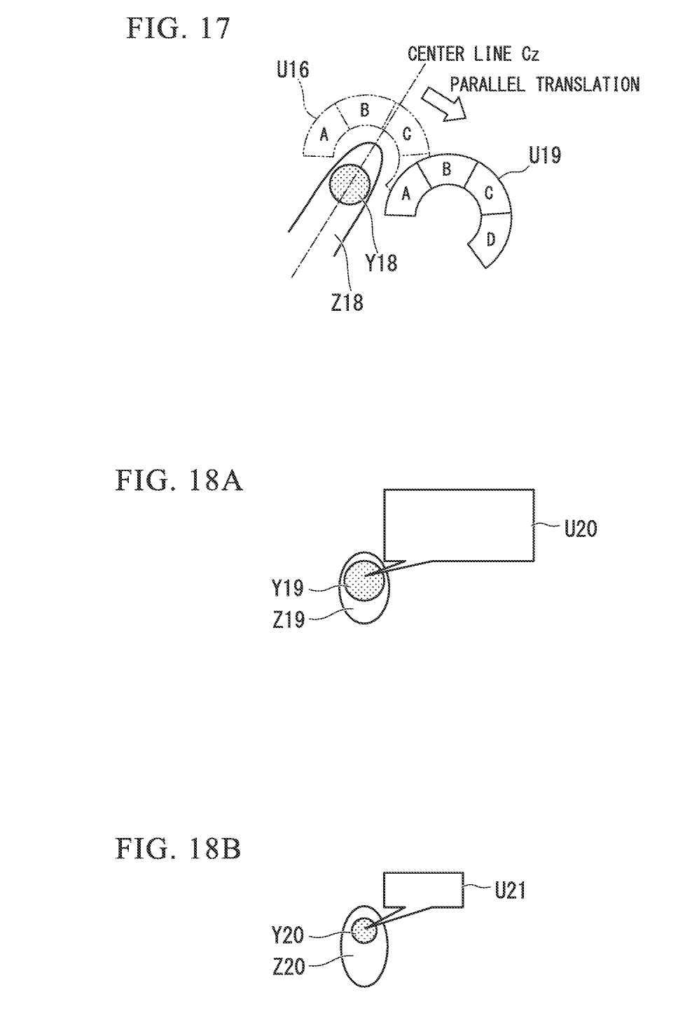

FIGS. 18A and 18B are schematic diagrams illustrating another example of the reduction and the expansion.

The UI component adjustment unit 123 may display a UI component to be larger as pressing force against the touch panel 111 using a manipulation object is greater, and to be smaller as the pressing force is smaller. Here, a relationship in which a ratio of a size of a contact area to a size of a proximity area is greater as the pressing force is greater, and the ratio of a size of a contact area to a size of a proximity area is smaller as the pressing force is smaller may be used. Here, the UI component adjustment unit 123 may determine a display area of the UI component to have a size corresponding to the pressing force.

In addition, when the touch panel 111 can detect pressing force of the manipulation object (for example, when the touch panel 111 includes a piezoelectric sensor), the UI component adjustment unit 123 may determine the display area of the UI component based on the pressing force detected by the touch panel 111. Accordingly, the user can intuitively recognize the pressing force.

Among two ellipses shown on the left in FIG. 18A, the outer ellipse indicates a proximity area Z19, and the inner filled ellipse indicates a contact area Y19. In this example, an area belonging to the contact area Y19 in an integrated detection area including the contact area Y19 and the proximity area Z19 is a main area. Therefore, the UI component adjustment unit 123 displays the UI component U20 to be large.

Among two ellipses shown on the left in FIG. 18B, the outer ellipse indicates a proximity area Z20, and the inner filled ellipse indicates a contact area Y20. In this example, an area that does not belong to the contact area Y20 in an integrated detection area including the contact area Y20 and the proximity area Z20 is a main area. Therefore, the UI component adjustment unit 123 displays the UI component U21 to be smaller than that in the example illustrated in FIG. 18A.

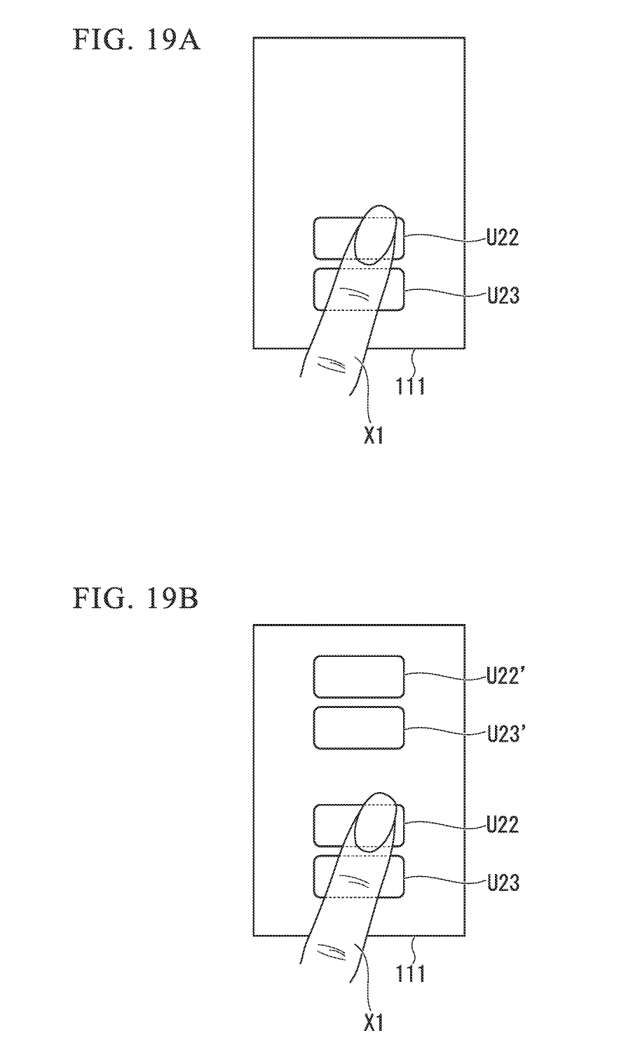

FIGS. 19A and 19B are schematic diagrams illustrating an example of replica display.

When a ratio of an overlap area to a display area of a displayed UI component exceeds a predetermined ratio, the UI component adjustment unit 123 may display a replica (copy) of the UI component in another position. An area in which the replica is displayed is, for example, an area in which other UI components are not displayed and is an area other than an integrated detection area including a contact area and a proximity area. Accordingly, the user can view the UI component covered with the manipulation object.

FIG. 19A illustrates that a manipulation object X1 comes in contact with an area in which two UI components U22 and U23 are displayed on a touch panel 111. In this case, each of sizes of integrated detection areas each including a proximity area and a contact area in sizes of the display areas of the UI components U22 and U23 exceeds a predetermined value.

FIG. 19B illustrates that UI components U22′ and U23′ that are respective replicas of the UI components U22 and U23 are displayed on the touch panel 111, in addition to the two UI components U22 and U23.

Thus, even when the UI components U22 and U23 are covered with the manipulation object X1, UI components U22′ and U23′ that are the replicas of the UI components are displayed in an area in which other UI components are not displayed and that is not covered with other manipulation objects. Therefore, the user can reliably view the UI components of the manipulation object, and can easily notice when a wrong operation is performed. In addition, when the replicated UI components U22′ and U23′ are displayed, the integrated detection area including the contact area and the proximity area, a touch position, or an area corresponding to both may be displayed in an aspect different from an aspect of surroundings on the display of the UI components U22′ and U23′. The display in the different aspect may be, for example, display using different colors or may be superimposition display of a watermark from the UI components U22′ and U23′ in the display using different colors. This enables the user to objectively recognize a manipulation state of the touch panel 111 and facilitates the manipulation.

As described above, the adjustment aspect of the UI component display area includes an adjustment aspect in which a display direction is changed, such as the point symmetry movement (see FIG. 12) and the rotation (see FIGS. 13 and 16). In the example illustrated in FIG. 12, a character string shown in the UI component U8 before the adjustment is displayed with top and bottom reversed and right and left reversed in the UI component U11 after the adjustment.

When the UI component display area is adjusted in the adjustment aspect in which the display direction is changed, the UI component adjustment unit 123 may readjust the direction of the character string to be shown in the UI component display area to be arranged in the direction before the adjustment. However, the UI component adjustment unit 123 does not readjust a position of a reference point (for example, a center point) of the character string to be shown after the adjustment.

Accordingly, the user can reliably recognize content of the character string shown in the UI component even after the UI component display area is adjusted.

In addition, the description has been given above on the assumption that the UI component adjustment unit 123 determines the overlap area based on the proximity area and the contact area that have been detected, for the UI component display area according to the input UI component information, to adjust a given UI component display area each time. This embodiment is not necessarily limited thereto. The UI component adjustment unit 123 may determine respective overlap areas for the display areas adjusted in one or more adjustment aspects in advance for the UI component display area according to the input UI component information. In this case, the UI component adjustment unit 123 may determine which of the display areas adjusted in one or more adjustment aspects is to be adopted based on the determined overlap area (or an overlapping rate).

Accordingly, the processes of adjusting the UI component display area are executed in parallel, thus reducing processing time and facilitating selection of an optimal UI component display area with a minimized overlap area or no overlap area. Thus, the user can smoothly perform the input manipulation.

As described above, in this embodiment, the contact area in which the manipulation object comes in contact with the UI component and the proximity area in which the manipulation object is close to the UI component without coming in contact with the UI component are detected, and the pointing coordinate pointed to by the manipulation object is detected based on the detected contact area. In addition, in the embodiment, a screen component area in which a screen component constituting the screen display is displayed is determined based on the detected pointing coordinate. Furthermore, in the embodiment, the arrangement of the screen component area is adjusted so that the overlap area that is an area in which the determined screen component area and the integrated detection area including the contact area and the proximity area that have been detected overlap becomes smaller.

Therefore, the screen component is displayed in the screen component area not covered with the manipulation object, thus improving operability related to the screen component since visibility of the screen component to the user is not obstructed.

### Second Embodiment

Next, a second embodiment of the present invention will be described.

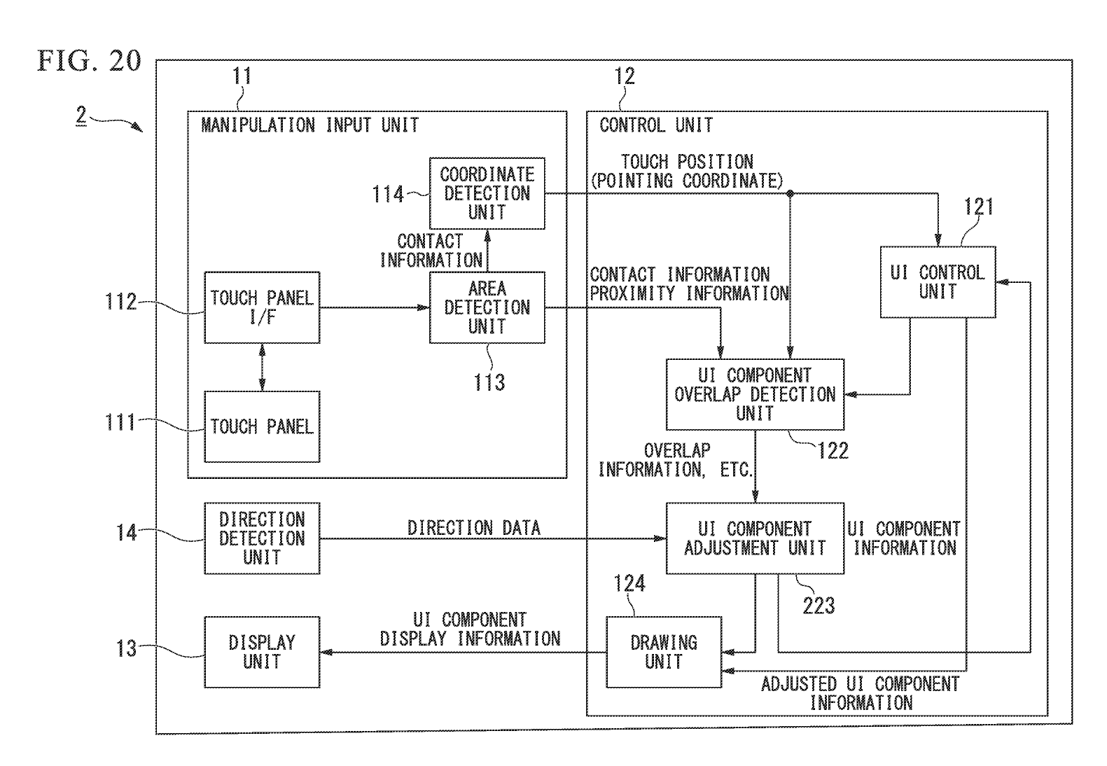

FIG. 20 is a block diagram illustrating an internal configuration of an electronic apparatus 2 according to this embodiment.

The electronic apparatus 2 includes a UI component adjustment unit 223 in place of the UI component adjustment unit 123 of the electronic apparatus 1 (see FIG. 3), and further includes a direction detection unit 14. In addition, an appearance configuration of the electronic apparatus 2 is the same as that of the electronic apparatus 1 (see FIG. 1).

The direction detection unit 14 detects a direction (that is, posture) of the electronic apparatus 2 that is based on a direction of gravity. The direction detection unit 14 includes, for example, a 3-axis acceleration sensor that can detect acceleration in three directions of X, Y and Z directions (see FIG. 1). For example, the direction detection unit 14 determines a greatest absolute value of acceleration among the X, Y and Z directions and whether the acceleration is positive or negative. For example, when the acceleration in the Y direction is highest and has a positive value, the direction detection unit 14 determines a “vertical direction” in which the Y direction is directed upward. In this case, since the direction of gravity approximates the Y direction in comparison with the X and Z directions, the acceleration in the Y direction is highest. For example, when the acceleration in the X direction is highest and has a negative value, the direction detection unit 14 determines a “right direction” in which the X direction is directed upward. For example, when the acceleration in the X direction is highest and has a positive value, the direction detection unit 14 determines a “left direction” in which the X direction is directed downward. The direction detection unit 14 outputs direction data indicating the determined direction to the UI component adjustment unit 223.

The UI component adjustment unit 223 has the same configuration as the UI component adjustment unit 123. However, the UI component adjustment unit 223 determines or selects adjustment conditions that are element information of the UI component adjustment unit according to the direction data input from the direction detection unit 14. The UI component adjustment unit 223, for example, determines the adjustment conditions to be parallel translation in the negative direction of the Y direction when the direction data indicates a “vertical direction,” and determines the adjustment conditions to be parallel translation in the negative direction of the X direction when the direction data indicates a “left direction.” Thus, the UI component adjustment unit 223 determines the parallel translation in the direction indicated by the direction data to be the adjustment conditions. In this case, the UI component display area is adjusted in a direction in which the manipulation object is highly likely to move away.

In addition, when the direction data indicates a direction other than the “vertical direction,” such as “left direction,” the UI component adjustment unit 223 may extract an outer edge of the proximity area and calculate a center line in a longitudinal direction of the extracted outer edge. In this case, the UI component adjustment unit 223 displays the UI component in a position resulting from a movement by a predetermined movement amount in a direction different from the calculated center line Cz, such as a vertical direction (see FIG. 17). Thus, the position of the UI component is adjusted to avoid the direction in which the manipulation object is directed, thus reducing a possibility of the displayed UI component being covered with the manipulation object. Further, the user can smoothly perform a manipulation input with respect to the electronic apparatus 2.

As described above, in this embodiment, the direction to which the electronic apparatus 2 is directed is detected and the adjustment conditions according to the detected direction are determined Therefore, since the arrangement of the screen component is adjusted according to the arrangement of the electronic apparatus 2, it is possible to remove or reduce the area that overlaps the manipulation object. Thus, the manipulation input by the user is facilitated.

### Third Embodiment

Next, a third embodiment of the present invention will be described.

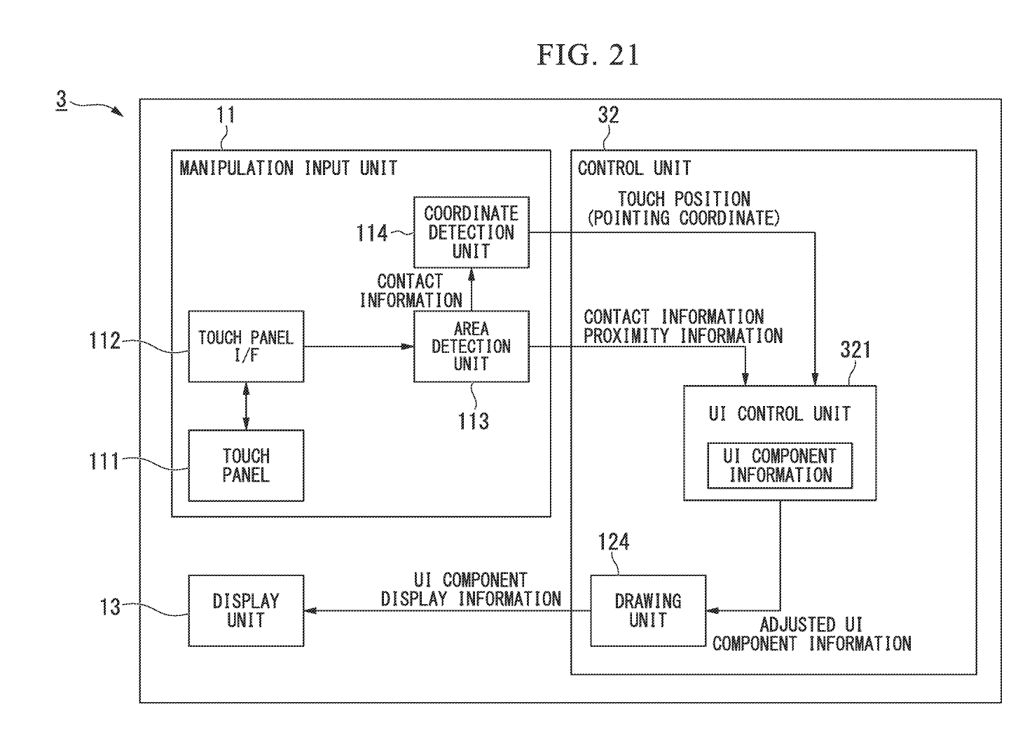

FIG. 21 is a block diagram illustrating an internal configuration of a display device according to this embodiment.

An electronic apparatus 3 includes a UI control unit 321 in place of the UI control unit 121 of the electronic apparatus 1 (see FIG. 3), and does not include the UI component overlap detection unit 122 and the UI component adjustment unit 123. In the electronic apparatus 3, the control unit 32 includes a UI control unit 321 and a drawing unit 124. The UI control unit 321 generates UI component information in which the UI component display area has been adjusted so that an overlap area that is an area in which a UI component display area and an integrated detection area including a contact area and a proximity area overlap is removed or is reduced. The drawing unit 124 is the same as that of the electronic apparatus 1 illustrated in FIG. 3 in that the UI component information in which the UI component display area has been adjusted is input and a UI component display image signal is generated based on the input UI component information. In addition, the appearance configuration of the electronic apparatus 3 is the same as that of the electronic apparatus 1 (see FIG. 1).

Next, an operation of the control unit 32, and mainly the UI control unit 321 according to this embodiment, will be described.

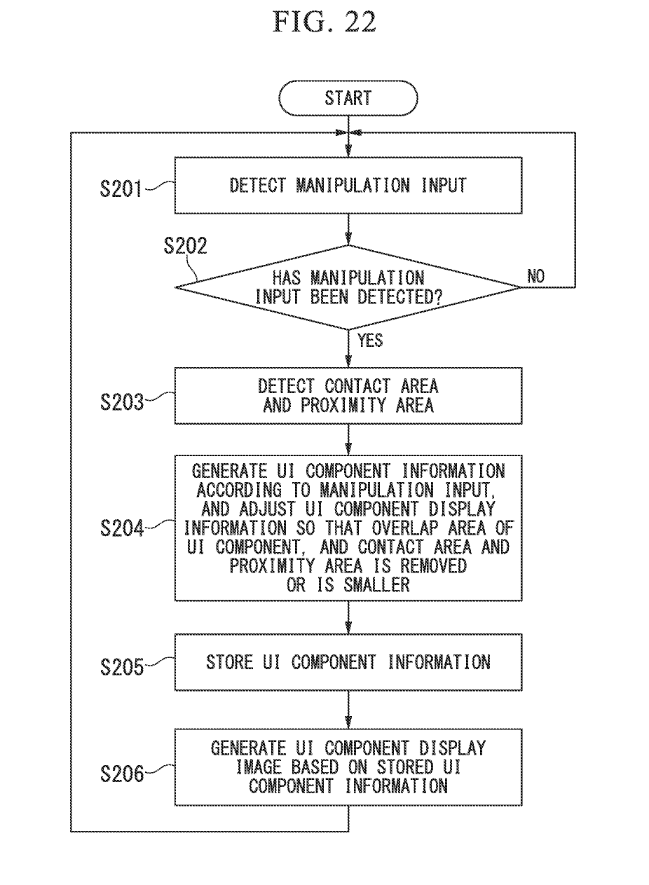

FIG. 22 is a flowchart illustrating an operation of the control unit according to this embodiment.

(Step S201) The UI control unit 321 attempts to detect a pointing coordinate input from the coordinate detection unit 114, that is, a manipulation input (touch manipulation) by a user at predetermined time intervals (for example, 1/32 second). The process then proceeds to step S202.

(Step S202) The UI control unit 321 determines whether the manipulation input has been detected. When it is determined that the manipulation input has been detected (YES in step S202), the process proceeds to step S203. When it is determined that the manipulation input has not been detected (NO in step S202), the process returns to step S201.

(Step S203) The UI control unit 321 detects an input of contact information indicating the contact area and proximity information indicating the proximity area from the area detection unit 113. The process then proceeds to step S204.

(Step S204) The UI control unit 321 adds the input pointing coordinate to the UI component information read from a storage unit to generate UI component information according to the manipulation input.

The UI control unit 321 adjusts arrangement of the UI component display area so that the overlap area of the UI component display area indicated by the generated UI component information and the integrated detection area based on the contact information and the proximity information is removed or is smaller. When the arrangement of the UI component display area is adjusted, the UI control unit 321 performs the same process as the UI component adjustment unit 123 described above.

The process then proceeds to step S205.

(Step S205) The UI control unit 321 adds the UI component display information indicating the adjusted UI component display area to the UI component information, and records (stores) the UI component information to which the UI component display area has been added in the storage unit included in the UI control unit 321. The process then proceeds to step S206.

(Step S206) The UI control unit 321 outputs the UI component information stored in the storage unit to the drawing unit 124. The drawing unit 124 superimposes an image of the UI component indicated by the UI component display information included in the UI component information input from the UI control unit 321 on an input application image. The drawing unit 124 outputs a UI component display image signal indicating the superimposed image to the display unit 13. Accordingly, the display unit 13 displays a UI component display image based on the UI component display image signal input from the drawing unit 124. The process then returns to step S201.

In addition, even in this embodiment, the direction detection unit 14 (see FIG. 20) that detects the direction to which the electronic apparatus 3 is directed may be included, and the UI control unit 321 may determine the adjustment conditions according to the direction detected by the direction detection unit 14. In that case, the UI control unit 321 adjusts the arrangement of the UI component display area based on the determined adjustment conditions.

As described above, in this embodiment, the screen component is displayed in the adjusted screen component display area without the adjustment of the screen component display area being repeated. Therefore, since a throughput and a processing delay related to the adjustment of the screen component display area according to the manipulation input can be reduced, operability related to the screen component by the user is improved.

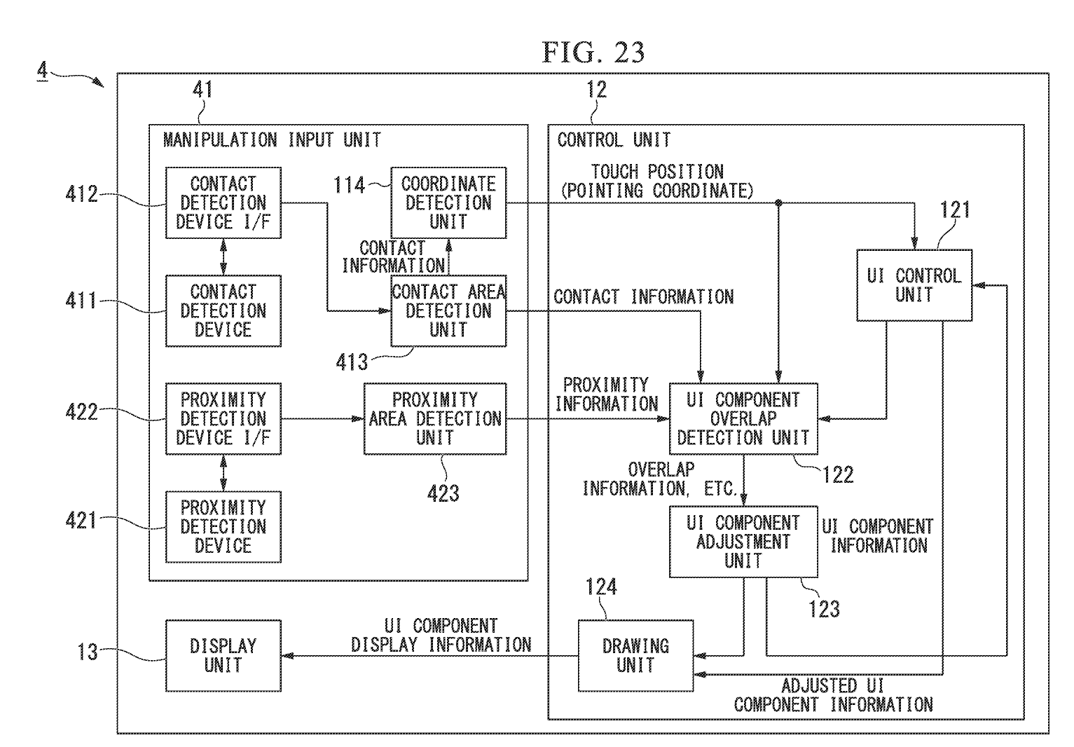

While the case in which the contact area detection unit that detects the contact area and the proximity area detection unit that detects the proximity area in the area detection unit 113 are integrally configured has been mainly described by way of example in the embodiment described above, the invention is not limited thereto. The contact area detection unit and the proximity area detection unit may be separately configured. For example, the electronic apparatus 4 includes a manipulation input unit 41 in place of the manipulation input unit 11 (see FIG. 3), as illustrated in FIG. 23.

FIG. 23 is a block diagram illustrating an internal configuration of an electronic apparatus 4 that is a modification example of the electronic apparatus 1.

A manipulation input unit 41 includes a contact detection device 411, a contact detection device I/F 412, a contact area detection unit 413, a proximity detection device 421, a proximity detection device I/F 422, a proximity area detection unit 423, and a coordinate detection unit 114.

The contact detection device 411 is, for example, a pressure-sensitive touch panel. The contact detection device I/F 412 outputs a contact detection signal indicating a contact position of the manipulation object from the contact detection device 411 to the contact area detection unit 413. The contact area detection unit 413 generates contact information indicating a contact area based on the contact detection signal input from the contact detection device I/F 412. The contact area detection unit 413 outputs the generated contact information to the coordinate detection unit and a UI component overlap detection unit 122.

The proximity detection device 421 is, for example, a capacitive touch panel. The proximity detection device I/F 422 outputs a proximity detection signal indicating a position in which the manipulation object is close to the touch panel from the proximity detection device 421 to the proximity area detection unit 423. The proximity area detection unit 423 generates proximity information indicating a proximity area based on the proximity detection signal input from the proximity detection device I/F 422. The proximity area detection unit 423 outputs the generated proximity information to the UI component overlap detection unit 122.

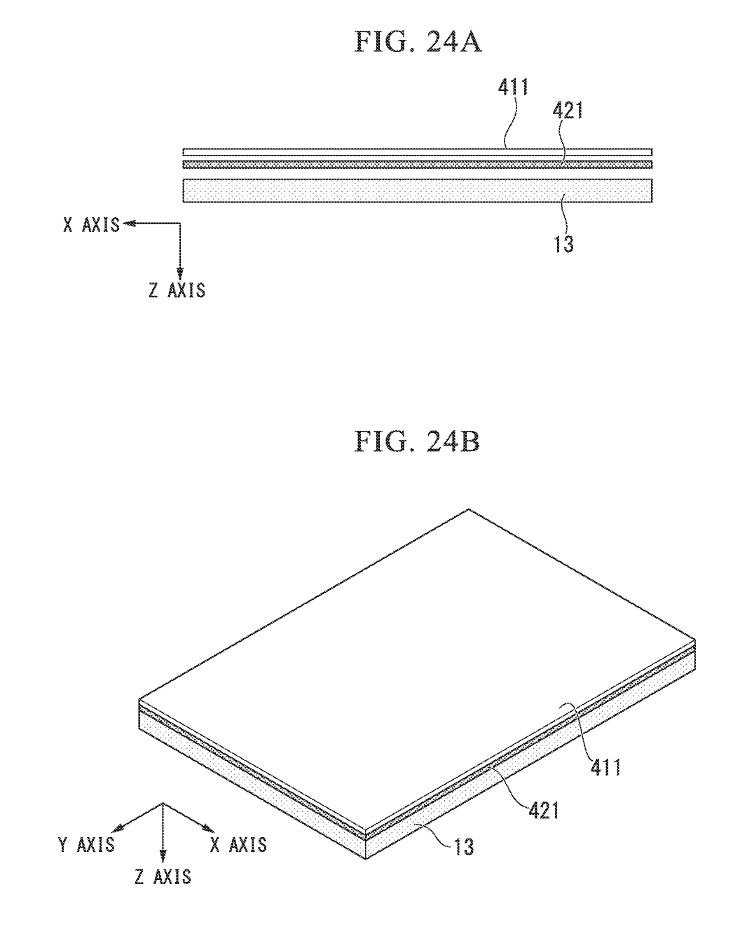

FIGS. 24A and 24B are arrangement diagrams of the contact detection device 411, the proximity detection device and the display unit 13 according to this modification example. FIG. 24A is a cross-sectional view, and FIG. 24B is a perspective view. A relationship among X, Y, and Z axes is the same as that shown in FIG. 1.

Here, the proximity detection device 421 and the contact detection device 411 overlap each other in the Z-axis direction on the surface of the display unit 13. Therefore, the contact detection device 411 detects the position in which the contact object comes in contact with the touch panel in an X-Y plane, and the proximity detection device 421 detects the position in which the contact object is close to the touch panel in the X-Y plane. In addition, the proximity detection device 421 and the contact detection device 411 are formed of a material that transmits light indicating an image radiated by the display unit 13. Accordingly, the user can view the image that is displayed by the display unit 13.

In addition, while the electronic apparatus 4 that includes the manipulation input unit 41 in place of the manipulation input unit 11 in the electronic apparatus 1 (see FIG. 3) has been described above by way of example, the embodiment described above is not limited thereto. The electronic apparatus 4 may include the manipulation input unit 41 in place of the manipulation input unit 11 in the electronic apparatus 2 or 3 (see FIG. 20 or 21).

In addition, some units of the electronic apparatuses 1, 2 and 3 in the embodiment described above, such as the UI control units 121 and 321, the UI component overlap detection unit 122, the UI component adjustment unit 123 and the drawing unit 124, may be realized by a computer. In this case, the units may be realized by recording a program for realizing a control function in a computer-readable recording medium, loading the program recorded in the recording medium to a computer system, and executing the program. In addition, the “computer system” described herein is a computer system embedded in the electronic apparatus 1, 2 or 3, and includes an OS or hardware such as a peripheral device. Further, the “computer-readable recording medium” refers to a portable medium such as a flexible disk, a magnetic optical disc, a ROM, or a CD-ROM, or a storage device such as a hard disk embedded in the computer system. Further, the “computer-readable recording medium” may include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system including a server and a client in such a case. Further, the program may be a program for realizing some of the above-described functions or may be a program capable of realizing the above-described functions in combination with a program previously stored in the computer system.

In addition, some or all of the electronic apparatuses 1, 2 or 3 in the embodiment described above may be realized as an integrated circuit, such as LSI (Large Scale Integration). Each functional block of the electronic apparatuses 1, 2 or 3 may be individually realized as a processor or some or all of the functional blocks may be integrated and realized as a processor. In addition, a scheme of realization as an integrated circuit is not limited to LSI, and the apparatus may be realized as a dedicated circuit or a general-purpose processor. In addition, when an integrated circuit technology for LSI replacement emerges with the advance of semiconductor technology, an integrated circuit according to the technology may be used.

While the embodiments of the present invention have been described above in detail with reference to the drawings, a concrete configuration is not limited to the above-described configuration, and various design changes or the like can be performed without departing from the summary of the present invention.

### INDUSTRIAL APPLICABILITY

The present invention is applicable to a manipulation input device, a manipulation input method, a manipulation input program, and an electronic apparatus in which degradation of operability in an electronic apparatus can be prevented.

### REFERENCE SYMBOLS

1, 2, 3, 4 . . . Electronic apparatus,
11, 41 . . . Manipulation input unit,
111 . . . Touch panel,
112 . . . Touch panel I/F,
113 . . . Area detection unit,
411 . . . Contact detection device,
412 . . . Contact detection device I/F,
413 . . . Contact area detection unit,
421 . . . Proximity detection device,
422 . . . Proximity detection device I/F,
423 . . . Proximity area detection unit,
114 . . . Coordinate detection unit,
12, 32 . . . Control unit,
121, 321 . . . UI control unit,
122 . . . UI component overlap detection unit,
123, 223 . . . UI component adjustment unit,
124 . . . Drawing unit,
13 . . . Display unit,
14 . . . Direction detection unit

1-14. (canceled)

15. A manipulation input device comprising:
a contact area detection unit configured to detect a first contact area in which a first manipulation object comes in contact with a manipulation input unit that receives a manipulation input;
a proximity area detection unit configured to detect a first proximity area in which the first manipulation object is close to the manipulation input unit without coming in contact with the manipulation input unit;
an overlap area detection unit configured to detect a first overlap area where a first screen component area in which a first screen component constituting a screen display is displayed and an area including the first contact area detected by the contact area detection unit and the first proximity area detected by the proximity area detection unit overlap; and
a screen component adjustment unit configured to adjust the first screen component area so that the first overlap area detected by the overlap area detection unit becomes smaller.

16. The manipulation input device according to claim 15,
wherein, in case that a plurality of adjustment aspects for adjusting an arrangement of the first screen component are determined, the screen component adjustment unit is configured to sequentially adjust the arrangement of the first screen component in each of the plurality of adjustment aspects according to a priority that differs according to a type of the first screen component.

17. The manipulation input device according to claim 15,
wherein, in case that a plurality of adjustment aspects for adjusting an arrangement of the first screen component are determined, the screen component adjustment unit is configured to determine the adjustment aspect in which the first overlap area is minimized among the plurality of adjustment aspects.

18. The manipulation input device according to claim 16,
wherein the adjustment aspect is any one or a combination of movement and deformation.

19. The manipulation input device according to claim 17,
wherein the adjustment aspect is any one or a combination of movement and deformation.

20. The manipulation input device according to claim 15,
wherein the screen component adjustment unit is configured to detect a direction in which a finger of a user is placed as the first manipulation object based on the first contact area and the first proximity area, and determine the first screen component area to be away from the detected direction.

21. The manipulation input device according to claim 15,
wherein the screen component adjustment unit is configured to determine a size of the first screen component area based on pressing force in case that the first manipulation object comes in contact with the manipulation input unit.

22. The manipulation input device according to claim 15, the manipulation input device comprising:
a direction detection unit configured to detect a direction in which the manipulation input device is directed,
wherein the screen component adjustment unit is configured to determine the first screen component area based on the direction detected by the direction detection unit.

23. The manipulation input device according to claim 15,
wherein the screen component adjustment unit is configured to replicate the first screen component area in a position that does not overlap the area including the first contact area and the first proximity area in case that the first overlap area is greater than a predetermined index value.

24. The manipulation input device according to claim 15,
wherein the overlap area detection unit is configured to detect the first overlap area in case that the manipulation input unit receives the manipulation input, and in case that the first screen component changes.

25. The manipulation input device according to claim 15,
wherein the contact area detection unit is configured to detect a second contact area in which a second manipulation object comes in contact with the manipulation input unit,
the proximity area detection unit is configured to detect a second proximity area in which the second manipulation object is close to the manipulation input unit without coming in contact with the manipulation input unit,
the overlap area detection unit is configured to detect a second overlap area where a second screen component area in which a second screen component constituting a screen display is displayed and an area including the second contact area detected by the contact area detection unit and the second proximity area detected by the proximity area detection unit overlap, and
the screen component adjustment unit is configured to adjust the second screen component area so that the second overlap area detected by the overlap area detection unit becomes smaller, and so that the first screen component area and the second screen component area do not overlap.

26. A manipulation input method used by a manipulation input device, the manipulation input method comprising:
a first process of detecting, by the manipulation input device, a contact area in which a manipulation object comes in contact with a manipulation input unit that receives a manipulation input;
a second process of detecting, by the manipulation input device, a proximity area in which the manipulation object is close to the manipulation input unit without coming in contact with the manipulation input unit;
a third process of detecting, by the manipulation input device, an overlap area where a screen component area in which a screen component constituting a screen display is displayed and an area including the contact area detected in the first process and the proximity area detected in the second process overlap; and
a fourth process of adjusting the screen component area so that the overlap area detected in the third process becomes smaller.

27. A non-transitory computer readable recording medium storing a manipulation input program used in a computer of a manipulation input device including a contact area detection unit that detects a contact area in which a manipulation object comes in contact with a manipulation input unit that receives a manipulation input, and a proximity area detection unit that detects a proximity area in which the manipulation object is close to the manipulation input unit without coming in contact with the manipulation input unit, the manipulation input program making the manipulation input device perform:
a first process of detecting an overlap area where a screen component area in which a screen component constituting a screen display is displayed and an area including the contact area detected by the contact area detection unit and the proximity area detected by the proximity area detection unit overlap; and
a second process of adjusting the screen component area so that the overlap area detected in the first process becomes smaller.

28. An electronic apparatus comprising:
a contact area detection unit configured to detect a contact area in which a manipulation object comes in contact with a manipulation input unit that receives a manipulation input;
a proximity area detection unit configured to detect a proximity area in which the manipulation object is close to the manipulation input unit without coming in contact with the manipulation input unit;
an overlap area detection unit configured to detect an overlap area where a screen component area in which a screen component constituting a screen display is displayed and an area including the contact area detected by the contact area detection unit and the proximity area detected by the proximity area detection unit overlap; and
a screen component adjustment unit configured to adjust the screen component area so that the overlap area detected by the overlap area detection unit becomes smaller.
